(19) United States
(12) Patent Application Publication
(10) Pub. No.: US 2007/0141507 A1
(43) Pub. Date: Jun. 21, 2007

(54) Curable polyester having an oxetanyl group at end and process for preparing the same, resist composition, jet printing ink composition, curing methods and uses thereof

(76) Inventors: Yuko Sakata, Kanagawa (JP); Hiroshi Uchida, Kanagawa (JP); Hirotoshi Kamata, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/578,494

(22) PCT Filed: Nov. 4, 2004
(86) PCT No.: PCT/JP04/16698

§ 371 Date: May 5, 2006

Related U.S. Application Data
(60) Provisional application No. 60/519,637, filed on Nov. 14, 2003.
(60) Provisional application No. 60/526,291, filed on Dec. 3, 2003.
(60) Provisional application No. 60/526,291, filed on Dec. 3, 2003.
(60) Provisional application No. 60/534,712, filed on Jan. 8, 2004.

(30) Foreign Application Priority Data
Nov. 6, 2003 (JP) 2003-376954
Nov. 15, 2003 (JP) 2003-393772
Dec. 24, 2003 (JP) 2003-428157

(51) Int. Cl. G03C 1/00

(52) U.S. Cl. 430/270.1

(57) ABSTRACT

There are provided a novel curable polyester, a cured product thereof, and a process for preparing the same, as well as a resist composition and a jet Printing ink composition comprising the curable polyester, curing methods and uses thereof. The curable polyester of the present invention has a polyester skeleton as a main chain and also has an oxetanyl group at the molecular end. The curable polyester of the present invention is excellent in curability and has excellent flexibility, adhesion and mechanical strength, and also exhibits high safety to the human. The resist composition containing a novel curable polyester having an oxetanyl group at the molecular end of the present invention is suitable for a solder resist for forming a pattern with high accuracy or an interlayer insulation film because neither bleeding after screen printing nor sagging upon heat curing occurs, and the jet printing ink composition containing a novel curable polyester having an oxetanyl group at the molecular end of the present invention is suitable for a solder resist or an interlayer insulation film, which is excellent in line width retention of a thin line pattern because neither bleeding nor sagging upon heat curing occurs.

### CROSS-REFERENCES TO RELATED APPLICATIONS

This application claims benefit under 35 U.S.C. section 119(e) to U.S. Provisional Application Ser. Nos. 60/519,637 filed Nov. 14, 2003, 60/526,291 filed Dec. 3, 2003, and 60/534,712 filed Jan. 8, 2004.

### TECHNICAL FIELD

The present invention relates to a novel curable polyester having an oxetanyl group at the molecular end, which is useful for various reactions such as ring-opening polymerization reaction and addition reaction, and to a process for preparing the same. The curable polyester having an oxetanyl group at the molecular end of the present invention can be used as various photocurable or thermosetting coating agents, adhesives and molding materials because it is excellent in flexibility, adhesion and mechanical properties and also exhibits high safety to the human body.

The present invention also relates to a thermosetting composition comprising the novel curable polyester, which is suited for use as an insulation protective film (solder resist) or an interlayer insulation film for print circuit boards. More particularly, it relates to a thermosetting resist composition which is suited for use as a solder resist for flexible print circuit board, a plating resist or an interlayer insulation material for multi-layered print circuit board and can be applied for formation of a pattern with high accuracy because it causes neither bleeding after pattern printing nor a change in line width due to sagging upon heat curing, and to its curing method and use.

The present invention further relates to a jet printing ink composition comprising the novel curable polyester. More particularly, it relates to a thermosetting jet printing ink composition suited for use as an insulation protective film (solder resist) or an interlayer insulation film, which can be applied for formation of a pattern with high accuracy because it causes neither bleeding nor a change in line width due to sagging upon heat curing after pattern printing according to an ink jet system, and to a method for curing the same.

### BACKGROUND ART

An oxetane compound as a 4-membered ring ether compound exhibits high reactivity because a carbon-oxygen bond is polarized, and also exhibits characteristics which can not be expected to a 3-membered ring epoxy compound in photocation polymerization and thermal cation polymerization, for example, no adverse influence of oxygen during polymerization, high polymerization rate and reduction in process cost. The oxetane compound is also characterized by high safety to the human body as compared with an epoxy compound having mutagenicity.

As a result of recent study on ring-opening reaction other than cation polymerization, Industrial Material, Vol. 49, No. 6, p53-60 (2001) discloses the reaction between an oxetane compound and an acyl halide compound, a thiol compound, a phenol compound or carboxylic acid. Since a new thermosetting system can be constructed, it is expected to remarkably extend industrial applicability.

By the above reason, various monofunctional and polyfunctional oxetane compounds have been reported. For example, Japanese Unexamined Patent Publication (Kokai) No. 7-17958 and Japanese Unexamined Patent Publication (Kokai) No. 2000-26444 disclose an oxetane compound having a vinyl group, Japanese Unexamined Patent Publication (Kokai) No. 10-204072 discloses an oxetane compound having a hydroxyl group, and Japanese Unexamined Patent Publication (Kokai) No. 2000-44670 discloses a monofunctional oxetane compound having a t-butylphenoxy group. Also Japanese Unexamined Patent Publication (Kokai) No. 11-130766 discloses an oxetane compound having a bisphenol skeleton, Japanese Unexamined Patent Publication (Kokai) No. 2000-336082 discloses an oxetane compound having a fluorene skeleton, Japanese Unexamined Patent Publication (Kokai) No. 2000-336133 discloses a compound having a novolak skeleton, Japanese Unexamined Patent Publication (Kokai) No. 2001-31664 discloses an oxetane compound having a naphthalene skeleton, and Japanese Unexamined Patent Publication (Kokai) No. 2001-31665 discloses a polyfunctional oxetane compound having a biphenyl skeleton.

In the soldering step which is performed when a wiring (circuit) pattern is protected from the external environment or electronic components are mounted to the surface of a print circuit board, a protective layer referred to as a cover coat or a solder resist is coated on the print circuit board by screen printing for the purpose of protecting so as to prevent solder from adhering on the unnecessary portion. With a trend of refining and densification of the circuit board, high accuracy of the solder resist has recently been required.

As the solder resist, thermosetting resist compositions have hitherto been used (see, for example, Japanese Unexamined Patent Publication (Kokoku) No. 5-75032, Japanese Unexamined Patent Publication (Kokai) No. 1-146964 and Japanese Unexamined Patent Publication (Kokai) No. 6-41485). However, these thermosetting solder resist compositions are cured by heating after printing a pattern such as thin line by a screen printing method. This method had problems that a resin component oozes out from the resist ink (so-called bleeding) because the resist composition is not cured immediately after pattern printing, and that sagging of ink occurs because viscosity decreases by heating upon curing, and thus line width becomes larger than the objective line width. Therefore, it has been considered it difficult to form a pattern having a line width of 100 μm or less with high accuracy by using the thermosetting solder resist composition.

To solve these problems, photo-solder resist compositions capable of forming a pattern by a photographic method have widely been used. Among these, a material capable of being developed with an aqueous alkali solution has exclusively been used in view of working environment and global environment. For example, Japanese Unexamined Patent Publication (Kokai) No. 64-62375, Japanese Unexamined Patent Publication (Kokai) No. 3-253093 and Japanese Examined Patent Publication (Kokoku) No. 1-54390 disclose photo-solder resist compositions using a resin obtained by reacting a phenolic or cresylic novolak type epoxy resin with an unsaturated monobasic acid and further reacting the reaction product with a saturated or unsaturated polybasic anhydride. Also Japanese Unexamined Patent Publication (Kokai) No. 8-134390 and Japanese Unexamined Patent Publication (Kokai) No. 11-65117 disclose photo-solder resist compositions using a resin obtained by reacting a bisphenol F type epoxy resin with an unsaturated monobasic acid and further reacting the reaction product with a saturated or unsaturated polybasic anhydride as a composition for flexible print circuit board. However, the photographic method had a problem that the number of operation processes increases and the yield of the product becomes worse because photocuring and alkali development are required, as compared with a simple heat curing solder resist.

The screen printing method had a problem that the thickness of the coating film and location accuracy vary due to deterioration of tension as a result of extension of a printing plate, and thus the printing plate must be remade in case of design change.

To solve these problems, Japanese Unexamined Patent Publication (Kokai) No. 9-214110 discloses a method for pattern printing of a solder resist according to an ink jet system, however, there is not any description about constituent features of a solder resist composition required to form a pattern with high accuracy. Also Japanese Unexamined Patent Publication (Kokai) No. 2001-332840 discloses a method comprising forming a photosensitive solder resist layer on a substrate, performing pattern printing of a light screening layer according to an ink jet system, and subjecting to exposure and alkali development to form a pattern with high accuracy. Although it is not necessary to remake the printing plate, this method had a problem that the number of operation processes increases and the yield of the product becomes worse because exposure and alkali development must be performed.

### SUMMARY OF THE INVENTION

An object of the present invention is to provide a novel curable polyester, which is excellent in curability, flexibility, adhesion and mechanical strength and also exhibits high safety to the human body, because it has a polyester skeleton as a main chain and also has an oxetanyl group at the molecular end, and to provide a process for preparing the same.

Another object of the present invention is to provide a thermosetting resist composition suited for use as a solder resist or an insulation protective film, which is capable of forming a pattern with high accuracy, by suppressing bleeding generated after screen printing or sagging generated upon heating, and to provide its use and curing method.

Another object of the present invention is to provide a jet printing ink composition suited for use as a solder resist or an insulation protective film, which is capable of printing according to an ink jet system without causing bleeding or a change in line width due to sagging upon heating, and forming a pattern with high accuracy.

The present inventors have intensively studied and found a curable polyester having an oxetanyl group at the molecular end, which is excellent in curability, flexibility, adhesion and mechanical strength, because the oxetanyl group can be easily introduced into the polyester molecular end by transesterification, and thus the present invention has been completed.

The present inventors also found that, when a curable polyester having an oxetanyl group at the molecular end is mixed with a resist composition, bleeding and sagging can be prevented and printed line width can be maintained.

The present inventors also found that, when a curable polyester having an oxetanyl group at the molecular end is mixed with a composition for solder resist, bleeding and sagging upon heat curing can be prevented and printed line width can be maintained when pattern printing is performed according to an ink jet system.

That is, the present invention provides a novel curable polyester having an oxetanyl group at the molecular end, its cured product, and a process for preparing the same, a resist composition comprising the curable polyester, a process for curing the same, and its use, as well as a jet printing ink composition comprising the curable polyester, a process for curing the same, and its use, of the following [1] to [26].
[1] A curable polyester having at least one oxetanyl group at the molecular ends.

[2] The curable polyester according to [1], which is obtained by transesterification of a compound (A) represented by the following formula (1): 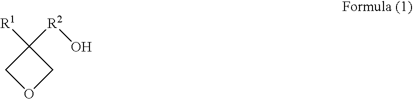
(wherein R¹ represents a hydrogen atom or an alkyl group having 1 to 6 carbon atoms, and R² represents an alkylene group having 1 to 6 carbon atoms), a compound (B) represented by the following formula (2):
   R³ [symbol] COOR⁴)ₙ Formula (2)
(wherein R³ represents a di- to tetra-valent organic group, R⁴ represents an alkyl or alkenyl group having 1 to 6 carbon atoms, and n represents an integer of 2 to 4) and a compound (C) represented by the following formula (3):
   R⁵ [symbol] OH)ₙ Formula (3)
(wherein R⁵ represents a di- to eicosa-valent organic group, and m represents an integer of 2 to 20).
[3] A curable polyester according to [1] or [2], having an oxetanyl group at both molecular ends, which has a structure represented by following formula (4): 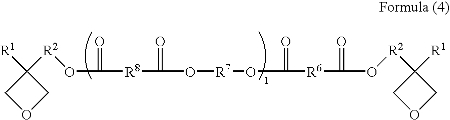
(wherein R¹ represents a hydrogen atom or an alkyl group having 1 to 6 carbon atoms, R² represents an alkylene group having 1 to 6 carbon atoms, R⁶ and R⁷ each represents a divalent organic group, and 1 represents an integer of 0 to 50).
[4] A cured product obtained by curing the curable polyester of any one of [1] to [3].
[5] A process for preparing a curable polyester, which comprises transesterifying a compound (A) represented by the following formula (1): 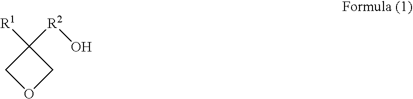
(wherein R¹ represents a hydrogen atom or an alkyl group having 1 to 6 carbon atoms, and R² represents an alkylene group having 1 to 6 carbon atoms), a compound (B) represented by the following formula (2):
   R³ [symbol] COOR⁴)ₙ Formula (2)
(wherein R³ represents a di- to tetra-valent organic group, R⁴ represents an alkyl or alkenyl group having 1 to 6 carbon atoms, and n represents an integer of 2 to 4) and a compound (C) represented by the following formula (3):
   R⁵ [symbol] OH)ₙ Formula (3)
(wherein R⁵ represents a di- to eicosa-valent organic group, and m represents an integer of 2 to 20).
[6] A resist composition comprising the curable polyester of any one of [1] to [3].
[7] The resist composition according to [6], wherein the content of the curable polyester is from 3 to 50% by weight based on the resin component of the composition.
[8] An ink comprising the resist composition of [6] or [7] and a colorant.
[9] A method for curing a resist composition, which comprises, performing pattern printing of the resist composition of [6] or [7] on a substrate, and curing a curable polyester of any one of [1] to [3] while melting with heating.
[10] The method for curing a resist composition according to [9], wherein a heat melting or heat curing temperature of the curable polyester of any one of [1] to [3] is from 40 to 250° C.
[11] A heat cured product of the resist composition of [6] or [7].
[12] An insulation protective film comprising a cured product of the resist composition of [6] or [7].
[13] An interlayer insulation film comprising a cured product of the resist composition of [6] or [7].
[14] A print circuit board comprising the insulation protective film of [12].
[15] A print circuit board comprising the interlayer insulation film of [13].
[16] A jet printing ink composition comprising the curable polyester of any one of [1] to [3].
[17] The jet printing ink composition according to [16], wherein the content of the curable polyester of any one of [1] to [3] is from 3 to 50% by weight based on the resin component of the composition.
[18] The jet printing ink composition according to [16], which comprises an epoxy resin (B) as the resin component other than the curable polyester of any one of [1] to [3].
[19] The jet printing ink composition according to [16], wherein resins in the essential component composition are dissolved in a solvent (C) or dispersed in the solvent (C).
[20] The jet printing ink composition according to [19], wherein the solvent (C) contains a solvent component having a boiling point of 180 to 260° C. and a vapor pressure at 20° C. of 133 Pa or less in the amount of 60% by weight or more based on the total amount of the solvent.
[21] A cured product obtained by drying and heating the solvent (C) of jet printing ink composition of [19] or [20].
[22] A method for curing a jet printing ink composition, which comprises, performing pattern printing on a substrate using the composition of any one of [16] to [20] according to an ink jet system, and curing the curable polyester of any one of [1] to [3] while melting with heating.
[23] An insulation protective film comprising a cured product of the jet printing ink composition of any one of [16] to [20].
[24] An interlayer insulation film comprising a cured product of the jet printing ink composition of any one of [16] to [20].
[25] A print circuit board comprising the insulation protective film of [23].
[26] A print circuit board comprising the interlayer insulation film of [24].

### BRIEF DESCRIPTION OF THE DRAWINGS

FIG. 1 is a ¹³C-NMR spectrum of a curable polyester having an oxetanyl group at the molecular end obtained in Preparation Example 1.

FIG. 2 is a ¹³C-NMR spectrum of a curable polyester having an oxetanyl group at the molecular end obtained in Preparation Example 2.

FIG. 3 is a ¹³C-NMR spectrum of a curable polyester having an oxetanyl group at the molecular end obtained in Preparation Example 3.

FIG. 4 is a ¹³C-NMR spectrum of a curable polyester having an oxetanyl group at the molecular end obtained in Preparation Example 4.

FIG. 5 is a schematic view showing an ink jet head of an ink jet applicator.

FIG. 6 is a view showing for explaining printing through an ink jet head shown in FIG. 5.

### EXPLANATION OF LETTERS OR NUMERALS

1: Ink Jet Head
2: Body
3: Ink Ejection Surface
4: Piezoelectric Element
5: Nozzle
6: Ink Chamber
7: Ink Droplet

### DETAILED DESCRIPTION OF THE INVENTION

The present invention will now be described in detail.

1. Curable Polyester Having an Oxetanyl Group at the Molecular end Obtained by Transesterification of a Compound (A), a Compound (B) and a Compound (C)

The curable polyester of the present invention can be formed into a curable polyester, which has a polyester skeleton as a main chain and also has an oxetanyl group at the molecular end, by transesterification of a compound (A) represented by the following formula (1), a compound (B) represented by the following formula (2) and a compound (C) represented by the following formula (3). 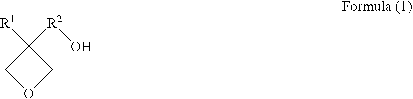
(wherein R¹ represents a hydrogen atom or an alkyl group having 1 to 6 carbon atoms, and R² represents an alkylene group having 1 to 6 carbon atoms)
R³ [symbol] COOR⁴)ₙ Formula (2)
(wherein R³ represents a di- to tetravalent organic group, R⁴ represents an alkyl or alkenyl group having 1 to 6 carbon atoms, and n represents an integer of 2 to 4)
R⁵ [symbol] OH)ₘ Formula (3)
(wherein R⁵ represents a di- to eicosavalent organic group, and m represents an integer of 2 to 20)

The reaction for synthesis of the curable polyester which has a polyester skeleton in the main chain and also has an oxetanyl group at the molecular end includes, for example, the followings:

(a) dehydration condensation reaction of a compound (A) represented by the formula (1), dicarboxylic acid, and a compound (C) represented by the formula (3);

(b) reaction of a compound (A) represented by the formula (1), dicarboxylic acid halide, and a compound represented by the formula (3); or

(c) transesterification of a compound (A) represented by the formula (1), a compound (B) represented by the formula (2), and a compound (C) represented by the formula (3).

In view of ease of the reaction and simple post-treatment process, the transesterification (c) is preferable. The respective raw materials used in the transesterification will now be described.

1-1. Compound (A) Represented by the Formula (1)

The compound (A) represented by the formula (1) used in present invention has an oxetanyl group and a hydroxyl group and may be used so as to introduce an oxetanyl group into the molecular end by transesterification.

In the formula, R¹ is preferably a hydrogen atom or an alkyl group having 1 to 6 carbon atoms. Specific examples of R¹ include methyl group, ethyl group, n-propyl group, n-butyl group, sec-butyl group, tert-butyl group, n-pentyl group and n-hexyl group. Among these groups, a methyl group and an ethyl group are particularly preferable in view of availability of the raw material.

R² is preferably an alkylene group having 1 to 6 carbon atoms which may be branched. Specific examples thereof include methylene group, ethylene group, propylene group, butylene group, pentylene group and hexylene group. Among these groups, a methylene group and an ethylene group are particularly preferable in view of availability of the raw material.

1-2. Compound (B) Represented by the Formula (2)

The compound (B) used in the present invention is used so as to control physical properties of the curable polyester having an oxetanyl group at the molecular end of the present invention.

In the formula, R³ represents a di- to tetravalent organic group (n=2 to 4). Since the curable polyester of the present invention may be gelled upon preparation when a large amount of the compound (B) having a tri- to tetravalent organic group is used, a compound (B) having a divalent organic group (n=2) is particularly preferable. As the compound (B), compounds having different R³ can also be used in combination.

When R³ is a divalent organic group, R³ is preferably an alkylene group which may have a substituent, an alkelene group which may have a substituent, a cycloalkylene group which may have a substituent, a cycloalkelene group which may have a substituent, or an arylene group which may have a substituent. Specific examples of the alkylene group which may have a substituent include ethylene group, propylene group, butylene group, pentylene group, hexylene group, heptylene group, octylene group, nonylene group, decylene group and dodecylene group; specific examples of the alkelene group which may have a substituent include vinylene group, methylvinylene group and propenylene group; specific examples of the cycloalkylene group which may have a substituent include cyclopentylene group, cyclohexylene group and methylcyclohexylene group; specific examples of the cycloalkelene group which may have a substituent include cyclopentenylene group, cyclohexylene group and methylcyclohexylene group; and specific examples of the arylene group which may have a substituent include phenylene group and naphthalylene group.

When R³ is a trivalent organic group, an alkanetriyl group which may have a substituent, a cycloalkanetriyl group which may have a substituent, and an arenetriyl group which may have a substituent are exemplified. Specific examples of the alkanetriyl group which may have a substituent include propanetriyl group, butanetriyl group, pentanetriyl group and hexanetriyl group; specific examples of the cycloalkanetriyl group which may have a substituent include cyclopentanetriyl group and cyclohexanetriyl group; and specific examples of the arenetriyl group which may have a substituent include benzenetriyl group and naphthalenetriyl group.

When R³ is a tetravalent organic group, an alkanetetrayl group which may have a substituent, a cycloalkanetetrayl group which may have a substituent, and an arenetetrayl group which may have a substituent are exemplified. Specific examples of the alkanetetrayl group which may have a substituent include butanetetrayl group, pentanetetrayl group and hexanetetrayl group; specific examples of the cycloalkanetetrayl group which may have a substituent include cyclopentanetetrayl group and cyclohexanetetrayl group; and specific examples of the arenetetrayl group include benzenetetrayl group and naphthalenetetrayl group.

R⁴ is preferably alkyl or alkenyl group having 1 to 6 carbon atoms so that it can be easily distill off from the reaction vessel by reactive distillation upon transesterification. An alkyl group having 1 to 4 carbon atoms or an alkenyl group having 3 to 4 carbon atoms is particularly preferable. Specific examples of the alkyl group as the substituent include methyl group, ethyl group, n-propyl group, isopropyl group, n-butyl group, sec-butyl group, tert-butyl group, n-pentyl group and n-hexyl group, and specific examples of the alkenyl group include allyl group and butenyl group.

Specific examples of the compound (B) used in the present invention include dimethyl ester, diethyl ester, di-n-propyl ester, diisopropyl ester, di-n-butyl ester, di-sec-butyl ester, diisobutyl ester, di-tert-butyl ester, di-n-pentyl ester, di-n-hexyl ester, diallyl ester and dibutenyl ester of succinic acid, glutaric acid, adipic acid, azelaic acid, sebacic acid, decanedicarboxylic acid, brasylic acid, 1,4-cyclohexanedicarboxylic acid, hexahydrophthalic acid, methyltetrahydrophthalic acid, endomethylenetetrahydrophthalic acid, methylendomethylenetetrahydrophthalic acid, chlorendic acid, fumaric acid, maleic acid, itaconic acid, citraconic acid, phthalic acid, isophthalic acid, terephthalic acid, 1,4-naphthalenedicarboxylic acid, 2,6-naphthalenedicarboxylic acid, 1,2,4-butanetricarboxylic acid, trimellitic acid, 1,2,3,4-butanetetracarboxylic acid, pyromellitic acid and benzophenonetetracarboxylic acid.

As the compound (B), compounds having different R² can also be used in combination.

1-3. Compound (C) Represented by the Formula (3)

The compound (C) used in the present invention is used so as to control physical properties of the curable polyester having an oxetanyl group at the molecular end of the present invention.

In the formula, R⁵ represents a di- to eicosavalent organic group (m=2 to 20). Since the curable polyester of the present invention may be gelled upon preparation when a large amount of the compound (C) having a tri- to eicosavalent organic group is used, a compound (C) having a divalent organic group (m=2) is particularly preferable. As the compound (C), compounds having different R⁵ can also be used in combination.

When R⁵ is a divalent organic group, an alkylene group which may have a substituent and a cycloalkylene group which may have a substituent are preferable. Specific examples of the alkylene group which may have a substituent include ethylene group, propylene group, butylene group, pentylene group, hexylene group, heptylene group, octylene group, nonylene group, decylene group, methylethylene group, 1-methylpropylene group and 2,2-dimethylpropylene group, and specific examples of the cycloalkylene group which may have a substituent include cyclopentylene group, cyclohexylene group, cycloheptylene group and cyclooctylene group.

When R⁵ is a trivalent organic group, an alkanetriyl group which may have a substituent and a cycloalkanetriyl group which may have a substituent are exemplified. Specific examples of the alkanetriyl group which may have a substituent include propanetriyl group, butanetriyl group, pentanetriyl group and hexanetriyl group, and specific examples of the cycloalkanetriyl group which may have a substituent include cyclopentanetriyl group and cyclohexanetriyl group.

When R⁵ is a tetravalent organic group, an alkanetetrayl group which may have a substituent and a cycloalkanetetrayl group which may have a substituent are exemplified. Specific examples of the alkanetetrayl group include butanetetrayl group, pentanetetrayl group and hexanetetrayl group, and specific examples of the cycloalkanetetrayl group which may have a substituent include cyclopentanetetrayl group and cyclohexanetetrayl group.

When R⁵ is a penta- or polyvalent organic group, a group having a plurality of di- to tetravalent organic groups is exemplified.

Specific examples of the compound (C) used in the present invention include ethylene glycol, 1,2-propanediol, 1,3-propanediol, 1,4-butanediol, 1,3-butanediol, 1,2-butanediol, 1,5-pentanediol, 1,6-hexanediol, 1,8-octanediol, 1,9-nonanediol, 1,12-dodecanediol, neopentyl glycol, 1,4-cyclohexanediol, 1,4-cyclohexane dimethanol and hydrogenated bisphenol A.

There can also be exemplified diethylene glycol, triethylene glycol, tetraethylene glycol, dipropylene glycol, tripropylene glycol, ethylene oxide 2 mol adduct of bisphenol A, ethylene oxide 4 mol adduct of bisphenol A, propylene oxide 2 mol adduct of bisphenol A, propylene oxide 4 mol adduct of bisphenol A, glycerin, trimethylolethane, trimethylolpropane and pentaerythritol.

When R⁵ is a penta- or polyvalent organic group, dipentaerythritol (pentavalent), sorbitol (hexavalent) and polyglycerin (H—(O—CH₂CH(OH)CH₂)ₙ—OH, n=5 to 20) are exemplified.

1-4. Preparation of Curable Polyester Having Oxetanyl Group at the Molecular End

The curable polyester having an oxetanyl group at the molecular end of the present invention can be prepared by transesterification of the compounds (A), (B) and (C). Upon transesterification, raw materials are reacted by the following three procedures.

(a) After transesterifying the compound (A) with the compound (B), the product is transesterified with the compound (C).

(b) After transesterifying the compound (B) with the compound (C), the compound (A) is added and the mixture is transesterified.

(c) All raw material are charged simultaneously and then transesterified.

In the present invention, the reaction may be conducted by any of the above three procedures.

The compounds (A), (B) and (C) are preferably charged in the following ratio in view of curability and physical properties of the resulting curable polyester.

First, a ratio of the equivalent a of a hydroxyl group of the compound A, the equivalent c of a hydroxyl group of the compound C and the equivalent b of an ester group of the compound B is preferably as follows:

b:c is from 0.1:1 to 0.95:1, and

a:(b−c) is from 0.5:1 to 1:4.

More preferably,

b:c is from 0.3:1 to 0.91:1, and

a:(b−c) is from 1:1 to 1:2.

As the catalyst for transesterification, a conventionally known transesterification catalyst can be used. Particularly preferable catalysts are alkali metals, alkali earth metals, Mn, U, Zn, Cd, Zr, Pb, Ti, Co, Sn and their oxides, weak acid salts, hydroxide organic acid salts, alcoholates and organic acid salts, and organotin compounds such as dibutyltin oxides, dioctyltin oxides and dibutyltin dichlorides. Among these catalysts, sodium carbonate, sodium hydroxide, sodium methoxide, potassium carbonate, potassium hydroxide, slaked lime, caustic lime, zinc acetate, Mn(acac)₂, tetraethoxytitanium and dibutyltin oxide are preferable.

The amount of these catalysts varies depending on activity of the catalyst and should be an amount which can distill an alcohol eliminated by transesterification at a suitable rate. The amount is generally from 0.0001 to 1 parts by weight, and preferably from 0.001 to 0.5 parts by weight, based on 100 parts by weight of the compound (B) as the raw material.

In the embodiment of the reaction, transesterification is conducted by heating to a boiling point of an alcohol having 1 to 6 carbon atoms derived from the compound (B) as the raw material or higher, and then alcohol having 1 to 6 carbon atoms thus produced is distilled off from a reaction vessel by reactive distillation so as to produce a polyester in an advantageous manner. The reaction is generally conducted under normal pressure or applied pressure. It is effective to use a method of rapidly distilling off the alcohol having 1 to 6 carbon atoms by evacuating the reaction system with the increase of a conversion ratio of the reaction.

As described above, when the reaction temperature is lower than the boiling point of the alcohol having 1 to 6 carbon atoms derived from the compound (B) as the raw material, the alcohol can not be effectively distilled off. On the other hand, when the reaction temperature is too high, there arise problems such as thermal polymerization and distillation of the compounds (C) and (A). Therefore, the reaction temperature is generally selected within a range from 100 to 250° C., and preferably from 130 to 200° C.

After the completion of the reaction, the curable polyester having an oxetanyl group at the molecular end can be taken out by various methods. For example, the curable polyester can be purified by removing the raw material and by-product due to distillation or reprecipitation using a proper poor solvent after the reaction. The curable polyester can be used as it is, and it is advantageous from an industrial point of view.

2. Curable Polyester Having Oxetanyl Group at Both Molecular Ends

Among curable polyesters having an oxetanyl group at the molecular end, a curable polyester having an oxetanyl group at both molecular ends shown in the structure represented by the following formula (4) is particularly preferable because it is excellent in practical safety. 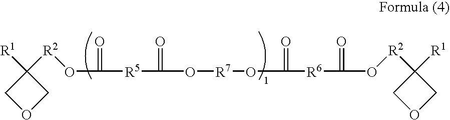
(wherein R¹ represents an alkyl group having 1 to 6 carbon atoms, R² represents an alkylene group having 1 to 6 carbon atoms, R⁶ and R⁷ each represents a divalent organic group, and 1 represents an integer of 0 to 50)

In the formula, R¹ is the same as R¹ of the formula (1) and is preferably an alkyl group having 1 to 6 carbon atoms. Specific examples thereof include methyl group, ethyl group, n-propyl group, n-butyl group, sec-butyl group, tert-butyl group, n-pentyl group and n-hexyl group. Among these groups, a methyl group and an ethyl group are particularly preferable in view of availability of the raw material.

R² is the same as R² of the formula (1) and is preferably an alkylene group having 1 to 6 carbon atoms. Specific examples thereof include methylene group, ethylene group, propylene group, butylene group, pentylene group and hexylene group. Among these groups, a methylene group and an ethylene group are particularly preferable in view of availability of the raw material.

R⁶ in the formula (4) is a moiety corresponding to the case where R³ of the compound (B) represented by the formula (2) is a divalent organic group. Physical properties of the curable polyester having an oxetanyl group at both molecular ends of the present invention can be optionally controlled by the structure of R⁶. In the formula, R⁶ is the same as R⁶ in case R³ is a divalent organic group, and R⁶ is an alkylene group which may have a substituent, an alkelene group which may have a substituent, a cycloalkylene group which may have a substituent, a cycloalkelene group which may have a substituent, or an arylene group which may have a substituent. Specific examples of the alkylene group which may have a substituent include ethylene group, propylene group, butylene group, pentylene group, hexylene group, heptylene group, octylene group, nonylene group, decylene group and dodecylene group; specific examples of the alkelene group which may have a substituent include vinylene group, methylvinylene group and propenylene group; specific examples of the cycloalkylene group which may have a substituent include cyclopentylene group, cyclohexylene group and methylcyclohexylene group; specific examples of the cycloalkelene group which may have a substituent include cyclopentenylene group, cyclohexenylene group and methylcyclohexenylene group; and specific examples of the arylene group which may have a substituent include phenylene group and naphthalylene group.

Two or more kinds of R⁶ may be used in combination.

R⁷ in the formula (4) is a moiety corresponding to the case where R⁵ of the compound (C) represented by the formula (3) is a divalent organic group. Similar to R⁶, R⁷ can optionally control properties of the curable polyester having an oxetanyl group at both molecular ends of the present invention. In the formula, R⁷ is the same as R⁷ in case R⁵ is a divalent organic group, and is preferably an alkylene group which may have a substituent or a cycloalkylene group which may have a substituent. Specific examples of the alkylene group which may have a substituent include ethylene group, propylene group, butylene group, pentylene group, hexylene group, heptylene group, octylene group, nonylene group, decylene group, methylethylene group, 1-methylpropylene group and 2,2-dimethylpropylene group; and specific examples of the cycloalkylene group which may have a substituent include cyclopentylene group, cyclohexylene group, cycloheptylene group and cyclooctylene group. Two or more kinds of R⁷ may be used in combination.

The polymerization degree 1 of the curable polyester having an oxetanyl group at both molecular ends represented by the formula (4) is preferably from 0 to 50. When 1 exceeds 50, the content of the oxetanyl group per unit weight decreases and thus curability drastically deteriorates. More preferably, 1 is from 1 to 30.

The content of the curable polyester resin in the resist composition or the jet printing ink composition of the present invention is preferably set within a range from 3 to 50% by weight based on the resin component of the composition. When the content is less than 3% by weight, severe bleeding and sagging occur upon heat curing and it is difficult to form a pattern with high accuracy. When the content exceeds 50% by weight, mechanical properties of the cured product obtained by curing the composition deteriorate.

3. Curing of Curable Polyester Having Oxetanyl Group at the Molecular End

The curable polyester having an oxetanyl group at the molecular end of the present invention can be cured by cation polymerization of the oxetanyl group at the end, or reacting with a crosslinking agent having a plurality of functional groups capable of reacting with the oxetanyl group.

In case of the curing reaction due to cation polymerization, an acid generator such as Lewis acid can be used. The oxetanyl group is excellent in polymerizability because less influence of oxygen inhibition is exerted upon cation polymerization.

Examples of the cation polymerization initiator include proton acid (e.g. sulfuric acid or perchloric acid), halogenated metal (BF₃) and organometallic compound.

Examples of the acid generating type cation polymerization initiator include known sulfonium salts, iodonium salts, phosphonium salts, diazonium salts, ammonium salts and ferrocenes.

Examples of the functional group capable of reacting with the oxetanyl group include carboxyl group and mercapto group.

Examples of the crosslinking agent having a plurality of functional groups capable of reacting with the oxetanyl group include compounds having three or more carboxyl groups per molecule, such as 1,2,4-butanetricarboxylic acid, trimellitic acid, 1,2,3,4-butanetetracarboxylic acid, pyromellitic acid and benzophenonetetracarboxylic acid; and compounds having three or more mercapto groups per molecule, such as trimethylolpropane tris(merpcatoacetate), trimethylolpropane tris(3-mercaptopropionate), pentaerythritol tetrakis(merpcatoacetate) and pentaerythritol tetrakis(3-mercaptopropionate).

When the curable polyester having an oxetanyl group at the molecular end of the present invention is cured, reactive monomers, fillers and various additives may be mixed, in addition to the initiators and crosslinking agents described above.

The curing reaction can be conducted by heating or exposing to active energy rays such as ultraviolet light and electron beam according to the kind of initiators and crosslinking agents.

4. Resin Component other than the Curable Polyester Having an Oxetanyl Group at the Molecular End

The resin component other than the curable polyester having an oxetanyl group at the molecular end used in the present invention is preferably an amorphous thermosetting resin which can react with the curable polyester having an oxetanyl group at the molecular end and also can be used in a composition for solder resist.

Examples of the thermosetting resin include epoxy resin, phenol resin, vinyl ester resin, polyester resin, urethane resin, silicone resin, acrylic resin, melamine derivative (for example, hexamethoxymelamine, hexabutoxylated malamine or fused hexamethoxymelamine), urea compound (for example, dimethylolurea), bisphenol compound (for example, tetramethylol bisphenol A) and oxazoline compound. These thermosetting resins can be used alone or in combination.

Examples of preferable resin include a polyester resin having at least three carboxyl groups per molecule in view of ease of the reaction with a curable polyester having an oxetanyl group at the molecular end, long-term insulating properties, heat resistance and processability. From the same points of view, an epoxy resin is preferably used.

4-1. Polyester Resin Having Carboxyl Group

A resin having at least three carboxyl groups per molecule is obtained, for example, by reacting a compound having at least two epoxy groups per molecule with a compound having at least two carboxyl groups per molecule to give a polyester resin and adding an acid anhydride to the polyester resin.

Examples of the compound having an epoxy group, which can be used. herein, include bisphenol A type epoxy resin, hydrogenated bisphenol A type epoxy resin, brominated bisphenol A type epoxy resin, bisphenol F type epoxy resin, novolak type epoxy resin, phenol novolak type epoxy resin, cresol novolak type epoxy resin, N-glycidyl type epoxy resin, novolak type epoxy resin of bisphenol A, rubber-modified epoxy resin, dicyclopentadiene phenolic type epoxy resin, silicone-modified epoxy resin, ε-caprolactone-modified epoxy resin, bisphenol S type epoxy resin, diglycidyl phthalate resin, heterocyclic epoxy resin, bixylenol type epoxy resin and biphenyl type epoxy resin are exemplified. In the present invention, these compounds having an epoxy resins can be used alone or in combination.

Examples of the compound having a carboxyl group, which can be used herein, include aliphatic dicarboxylic acids such as fumaric acid, maleic acid, succinic acid, itaconic acid, adipic acid and cyclohexanedicarboxylic acid; aromatic dicarboxylic acids such as phthalic acid, isophthalic acid and terephthalic acid; tricarboxylic acids such as 1,2,4-butanetetracarboxylic acid and trimellitic acid; and tetracarboxylic acids such as 1,2,3,4-butanetetracarboxylic acid, pyromellitic acid and benzophenonetetracarboxylic acid. Among these compounds, aliphatic dicarboxylic acids such as fumaric acid, maleic acid, succinic acid, itaconic acid, adipic acid and cyclohexanedicarboxylic acid are particularly preferable because of crystallinity of the resulting resin and no fear of gelation during the reaction. These compounds having a carboxyl group can be used alone or in combination.

In the reaction between the above compound having an epoxy group and the above compound having a carboxyl group, a catalyst is preferably added in view of the reaction rate and yield. Examples of preferable catalyst include phosphine compounds such as triphenylphosphine.

Examples of the acid anhydride, which can be used herein, include dicarboxylic anhydrides such as maleic anhydride, succinic anhydride, itaconic anhydride, dodecenylsuccinic anhydride, phthalic anhydride, tetrahydrophthalic anhydride, methyltetrahydrophthalic anhydride, hexahydrophthalic anhydride, methylhexahydrophthalic anhydride, endomethylenetetrahydrophthalic anhydride and methylendomethylenetetrahydrophthalic anhydride and chlorendic anhydride; tricarboxylic anhydrides such as trimellitic anhydride; tetracarboxylic anhydrides such as pyromellitic anhydride and benzophenonetetracarboxylic anhydride. Among these acid anhydride, dicarboxylic anhydrides such as maleic anhydride, succinic anhydride, itaconic anhydride, dodecenylsuccinic anhydride, phthalic anhydride, tetrahydrophthalic anhydride, methyltetrahydrophthalic anhydride, hexahydrophthalic anhydride, methylhexahydrophthalic anhydride, endomethylenetetrahydrophthalic anhydride and methylendomethylenetetrahydrophthalic anhydride and chlorendic anhydride are particularly preferable because of no fear of gelation during the reaction.

4-2-1. Epoxy Resin

The epoxy resin is a compound having at least two oxirane groups per molecule and specific examples thereof include epoxy resins having et least two epoxy groups per molecule such as bisphenol A type epoxy resin, hydrogenated bisphenol A type epoxy resin, brominated bisphenol A type epoxy resin, bisphenol F type epoxy resin, novolak type epoxy resin, phenol novolak type epoxy resin, cresol novolak type epoxy resin, N-glycidyl type epoxy resin, novolak type epoxy resin of bisphenol A, rubber-modified epoxy resin, dicyclopentadiene phenolic type epoxy resin, silicone-modified epoxy resin and ε-caprolactone-modified epoxy resin. Furthermore, bisphenol S type epoxy resin, diglycidyl phthalate resin, heterocyclic epoxy resin, bixylenol type epoxy resin and biphenyl type epoxy resin are exemplified.

Also a polyester resin having at least two epoxy groups per molecule obtained by reacting such an epoxy resin with a compound having at least two carboxyl groups per molecule can be used.

Examples of the compound having at least two carboxyl groups per molecule include aliphatic dicarboxylic acids such as fumaric acid, maleic acid, succinic acid, itaconic acid, adipic acid and cyclohexanedicarboxylic acid; aromatic dicarboxylic acids such as phthalic acid, isophthalic acid and terephthalic acid; tricarboxylic acids such as 1,2,4-butanetetracarboxylic acid and trimellitic acid; and tetracarboxylic acids such as 1,2,3,4-butanetetracarboxylic acid, pyromellitic acid and benzophenonetetracarboxylic acid. Among these compounds, aliphatic dicarboxylic acids such as fumaric acid, maleic acid, succinic acid, itaconic acid, adipic acid and cyclohexanedicarboxylic acid are particularly preferable because of crystallinity of the resulting resin and no fear of gelation during the reaction. These compounds having a carboxyl group can be used alone or in combination.

The reaction between the above epoxy resin and the compound having at least two carboxyl groups per molecule is preferably conducted so that a molar ratio of the epoxy group to the carboxyl group is more than 1. When the molar ratio of the epoxy group to the carboxyl group is less than 1, a polyester resin having no epoxy group is produced. In the present invention, these epoxy resins can be used alone or in combination.

4-2-2. Curing Catalyst of Epoxy Resin

The epoxy resin can be cured in the presence of a curing catalyst. As the curing catalyst, a compound having a catalytic action of accelerating polymerization of an epoxy group of tertiary amine or an imidazole compound is used.

Specific examples of the tertiary amine compound include triethylamine, dimethylcyclohexylamine, N,N-dimethylpiperazine, benzyl dimethylamine, 2-(N,N-dimethylaminomethyl)phenol, 2,4,6-tris(N,N-dimethylaminomethyl)phenol and 1,8-diazabiscyclo(5.4.0)undecene-1.

Specific examples of the imidazole compound include 2-methylimidazole, 2-ethyl-4-methylimidazole, 2-phenylimidazole, 2-undecylimidazole, 1-cyanoethyl-2-methylimidazole, 1-cyanoethyl-2-phenylimidazole, 1-cyanoethyl-2-undecylimidazole, 1-cyanoethyl-2-methylimidazole trimellitate, 1-cyanoethyl-2-undecylimidazolium trimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2-methylimidazole-isocyanuric acid adduct, 2-phenylimidazole-isocyanuric acid adduct and 2,4-diamino-6-[2′-methylimidazolyl-(1′)]-ethyl-s-triazine isocyanuric acid adduct.

Further detailed specific examples of these tertiary amine compounds and imidazole compounds are described in “New Development in Epoxy Resin Curing Agent” (published by CMC Publishing Co., Ltd., 1994), pages 94 to 107.

4-2-3. Curing Agent of Epoxy Resin

In addition to a curing catalyst of an epoxy resin, a compound having a functional group capable of reacting with the epoxy group can be used as the curing agent. Examples of the curing agent include compounds having a functional group to be added to the epoxy group, such as primary or secondary amine compound, acid anhydride compound and phenolic compound.

Specific examples of the primary or secondary amine compound include aliphatic amines such as ethylenediamine, triethylenetetramine, polyoxypropylenediamine, isophoronediamine, bis(4-amino-3-methyldicyclohexyl)methane, bis(aminomethyl)cyclohexane, norbornenediamine, 3,9-bis(3-aminopropyl)-2,4,8,10-tetraoxaspiro(5.5)undecane and m-xylylenediamine; and aromatic amines such as m-phenylenediamine, diaminodiphenylmethane, diaminodiphenylsulfone and α,α′-bis(4-aminophenyl)-p-diisopropylbenzene. More specifically, these primary or secondary amine compounds are described in “New Development in Epoxy Resin Curing Agent” (published by CMC Publishing Co., Ltd., 1994), pages 41 to 93.

Examples of the acid anhydride compound include maleic anhydride, succinic anhydride, itaconic anhydride, dodecenylsuccinic anhydride, phthalic anhydride, tetrahydrophthalic anhydride, methyltetrahydrophthalic anhydride, hexahydrophthalic anhydride, methylhexahydrophthalic anhydride, endomethylenetetrahydrophthalic anhydride, methylendomethylenetetrahydrophthalic anhydride, chlorendic anhydride, trimellitic anhydride, pyromellitic anhydride, benzophenonetetracarboxylic anhydride, ethylene glycol bis(unhydrotrimellitate), glycerol tris(unhydrotrimellitate), polyazelaic anhydride, polydodecane dianhydride and 7,12-dimethyl-7,11-octadecadiene-1,18-dicarboxylic partial anhydride. More specifically, these acid anhydride compounds are described in “New Development in Epoxy Resin Curing Agent” (published by CMC Publishing Co., Ltd., 1994), pages 117 to 145.

Specific examples of the phenolic compound include bisphenol F, bisphenol A, bisphenol S, phenol novolak, o-cresol novolak, p-cresol novolak, t-butylphenol novolak, dicyclopentadiene cresol, poly-p-vinylphenol and bisphenol A type novolak. More specifically, these phenolic compounds are described in “New Development in Epoxy Resin Curing Agent” (published by CMC Publishing Co., Ltd., 1994), pages 149 to 162.

Since the acid anhydride compound and the phenolic compound enhance reactivity with the epoxy group, the above-described tertiary amine and imidazole compounds may be added.

5. Solvent (C)

In the jet printing ink composition of the present invention, a solvent (C) is optionally added so as to prepare an ink capable of ejecting through a head from the composition. As the solvent, a solvent having a boiling point of 180 to 260° C., particularly 210 to 260° C., and a vapor pressure at 20° C. of 133 Pa (1.0 mmHg) or less is used as a main solvent so as to smoothly eject an ink through a head of an ink jet system and to suppress rapid drying at a nozzle tip. The main solvent is preferably added in the amount of 50% by weight or more, and particularly preferably 60% by weight or more, based on the total amount of the solvent (C).

The solvent component having a boiling point of 180 to 260° C. and a vapor pressure at 25° C. of 133 Pa (1.0 mmHg) or less has suitable drying property and evaporability. Therefore, when solvents having a high content of the solvent component are used alone or in combination, since they are not rapidly dried at the nozzle tip of a recording head, neither rapid increase in viscosity of the ink nor clogging occurs, and thus an adverse influence is not exerted on rectilinearity of ejection and stability. Also since drying proceeds at a suitable rate after spraying over the ejected surface, it is made possible to rapidly dry the solvent in the ink during an air drying step of a conventional heating step after the ink fitted with the ejected surface and the surface of the coating film became horizontal and smooth.

Specific examples of preferable main solvent include diethylene glycol diacetate (boiling point: 250° C., 3 Pa (20° C.)), diethylene glycol monobutyl ether acetate (boiling point: 247° C., 1.3 Pa or less (20° C.)), diethylene glycol monoethyl ether acetate (also referred to as ethyl carbitol acetate; boiling point: 217° C., 13 Pa or less (20° C.)), diethylene glycol dibutyl ether (boiling point: 254° C., 1.3 Pa (20° C.)), diethyl adipate (boiling point: 251° C., 160 Pa (78° C.)), N-methyl pyrrolidone (boiling point: 202° C., 45 Pa (20° C.)) and 2-ethylhexyl acetate (boiling point: 199° C., 53 Pa (20° C.)).

In the present invention, conventional solvents can be used in combination with the above main solvents. Specific examples thereof include toluene, xylene, ethylbenzene, cyclohexane, ethylene glycol diethyl ether, diethylene glycol dimethyl ether, diethylene glycol diethyl ether, propylene glycol monomethyl ether acetate, propylene glycol monoethyl ether acetate, methyl methoxypropionate, ethyl methoxypropionate, methyl ethoxypropionate, ethyl ethoxypropionate, isoamyl acetate, ethyl lactate, γ-butyrolactone, cyclohexanone and N,N-dimethylformamide.

The content of the solvent (C) in the jet printing ink composition of the present invention is preferably from 40 to 95% by weight. When the content is less than 40% by weight, viscosity becomes too high and it becomes difficult to eject the ink through an ink jet head, and thus making it possible to print using an ink jet system. When the content is more than 95% by weight, the thickness of the printable film decreases and insulation properties required to a solder resist deteriorate. More preferably, the content is from 50 to 90% by weight.

Suitable viscosity of the jet printing ink composition of the present invention is preferably adjusted within a range from 0.1 to 100 mPa·s [as measured by a B type viscometer (Brookfield Viscometer)]. More preferably, the viscosity is from 0.5 to 80 mPa·s. The viscosity within the above range is more suited for application or printing onto the object, resulting in good usability. When the viscosity can not be adjusted within the above range at normal temperature, the viscosity may be reduced by heating.

6. Colorant

The jet printing ink composition of the present invention may contains colorants which are added in a conventional jet printing ink. Examples of the colorant include phthalocyanine blue, phthalocyanine green, iodine green, disazo yellow, crystal violet, titanium oxide, carbon black and naphthalene black. More specifically, these colorants are described in “Latest Pigment Application Technology” (published by CMC Publishing Co., Ltd., 1988), pages 337 to 342 and “Special Functional Pigment” (published by CMC Publishing Co., Ltd., 1988), pages 175 to 183.

7. Other Constituent Components

7-1. Inorganic Filler

The resist composition of the present invention may contain inorganic fillers so as to improve viscosity characteristic, heat resistance and hardness.

The jet printing ink composition of the present invention may contain inorganic fillers so as to improve viscosity characteristic, heat resistance and hardness as far as clogging of the ink jet head does not occur.

Specific examples of the inorganic filler include talc, barium sulfate, barium titanate, silica, alumina, clay, magnesium carbonate, calcium carbonate and silicate compound.

7-2. Organic Solvent

To the resist composition of the present invention, an organic solvent may be optionally added so as to adjust the viscosity before use. It becomes easy to apply or print the composition onto the object by adjustment of the viscosity.

Examples of the organic solvent include isopropanol, 1-butanol, toluene, xylene, ethylbenzene, cyclohexane, isophorone, ethylene glycol monoacetate, diethylene glycol dimethyl ether, ethylene glycol diethyl ether, ethylene glycol monomethyl ether, ethylene glycol monoethyl ether, ethylene glycol mono-n-butyl ether, propylene glycol monomethyl ether, propylene glycol methyl ether acetate, propylene glycol ethyl ether acetate, diethylene glycol mono ethyl ether acetate (also referred to as ethyl carbitol acetate), methyl methoxypropionate, ethyl methoxypropionate, methyl ethoxypropionate, ethyl ethoxypropionate, ethyl acetate, isoamyl acetate, ethyl lactate, acetone, methyl ethyl ketone, cyclohexanone, N,N-dimethylformamide, N-methyl pyrrolidone and γ-butyrolactone. These organic solvents may be used alone or in combination.

The amount of the organic solvent is preferably adjusted so that the viscosity of the resist composition is adjusted within a range from 500 to 500,000 mPa·s [as measured at 25° C. by a B type viscometer (Brookfield Viscometer)]. More preferably, the viscosity is from 1,000 to 500,000 mPa·s. The viscosity within the above range is more suited for application or printing onto the object, resulting in good usability.

7-3. Flame Retardance Imparting Agent

In case of a solder resist, flame retardance is sometimes required according to the purposes. In that case, flame retardance imparting agents may be added.

Examples of the flame retardance imparting agent include bromine compounds, hydrated metal compounds, phosphorous compounds and antimony compounds.

7-3-1. Bromine Compound

Specific examples of the bromine compound include brominated bisphenol A type epoxy resin, brominated cresol novolak type epoxy resin, tetrabromobisphenol A carbonate oligomer, tetrabromobisphenol A, tetrabromobisphenol A-bis(2,3-dibromopropyl ether), tetrabromobisphenol A-bis(allyl ether), tetrabromobisphenol A-bis(bromoethyl ether), tetrabromobisphenol A-bis(ethoxylate), tetrabromobisphenol S, tetrabromobisphenol S-bis(2,3-dibromopropyl ether), brominated phenyl glycidyl ether, hexabromobenzene, pentabromotoluene, hexabromocyclododecane, decabromodiphenyl oxide, octabromodiphenyl oxide, ethylenebis(pentabromophenyl), ethylenebis(tetrabromophthalimide), tetrabromophthalic anhydride, tribromophenol tris(tribromophenoxy)triazine, polydibromophenylene oxide, bis(tribromophenoxyethane), tribromoneopentyl glycol, dibromoneopentyl glycol, pentabromobenzyl acrylate, dibromostyrene, tribromostyrene, poly(pentabromobenzyl acrylate) and polybromostyrene.

7-3-2. Hydrated Metal Compound

The hydrated metal compound is a metal compound containing crystal water and examples thereof include, but are not limited to, those wherein the amount of water combined per mol as measured by thermal analysis is within a range from 12 to 60% (% by weight). In view of flame-retardant effect, a hydrated metal compound whose endotherm upon pyrolysis of 400 J/g or more, preferably 600 to 2500 J/g, is used. Specific examples of the hydrated metal compound include aluminum hydroxide, magnesium hydroxide, calcium hydroxide, dawsonite, calcium aluminate, dihydrated gypsum, zinc borate, barium metaborate, zinc hydroxystannate, kaolin and vermiculite. Among these hydrated metal compounds, aluminum hydroxide or magnesium hydroxide is particularly preferable.

7-3-3. Phosphorus Compound

The phosphorus compound is preferably a compound having a chemical structure of “P-O-Z” (Z is an organic group) and a phosphorus compound having a tri- or tetravalent phosphorus atom is generally used. Examples of the phosphorus compound having a trivalent phosphorus atom include phosphite compound, phosphonite compound and phosphinite compound. Examples of the phosphorus compound having a pentavalent phosphorus atom include phosphate compound, phosphonate compound and phosphinate compound. Among these compounds, a phosphate ester compound having a pentavalent phosphorus atom is preferably used in view of storage stability. The organic group for forming an ester of these phosphate ester compounds may be any of aliphatic hydrocarbon group, aromatic hydrocarbon group and alicyclic hydrocarbon group. Among these organic groups, an aromatic hydrocarbon group is preferable in view of flame retardance and solder heat resistance.

Examples of the phosphate ester compound include triphenyl phosphate, tricresyl phosphate, trixylenyl phosphate, cresyldiphenyl phosphate, resolcinol bis(diphenol)phosphate, bisphenol A bis(diphenylphosphate) and 2-ethylhexyldiphenyl phosphate.

In addition to the above phosphorus compounds, a phosphazene compound having a structure of “—P(Z)₂═N—” (Z is an organic group) can also be used without causing any problem.

7-3-4. Antimony Compound

Specific examples of the antimony compound include antimony trioxide, antimony tetraoxide, antimony pentaoxide and sodium antimonate.

7-4. Other Additives

To the resist composition of the present invention, colorants may be further added before use. Examples of the colorant include phthalocyanine blue, phthalocyanine green, iodine green, disazo yellow, crystal violet, titanium oxide, carbon black and naphthalene black. When used as the ink, the viscosity is preferable within a range from 500 to 500,000 mPa·s [as measured at 25° C. by a B type viscometer (Brookfield Viscometer)].

To improve fluidity, waxes and surfactants can be added. Specific examples of the wax include polyamide wax and polyethylene oxide wax. Specific examples of the surfactant include silicone oil, higher fatty acid ester and amide. These fluidity modifiers can be used alone or in combination. The above inorganic fillers are preferably used because not only fluidity of the resist composition, but also characteristics such as adhesion and hardness can be improved.

To the resist composition and the jet printing ink composition of the present invention, additives such as thermal polymerization inhibitors, thickeners, defoamers, leveling agents and tackifying agents can be added, if necessary. Examples of the thermal polymerization inhibitor include hydroquinone, hydroquinone monomethyl ether, tert-butyl catechol, pyrogallol and phenothiazine. Examples of the thickener include asbestos, orven, bentone and montmorillonite. The defoamer is used so as to eliminate bubbles formed upon printing, coating and curing and specific examples thereof include acrylic and silicone surfactants. The leveling agent is used so as to eliminate unevenness of the surface of the coating film formed upon printing and coating and specific examples thereof include acrylic and silicone surfactants. Examples of the tackifying agent include imidazole, thiazole, triazole and silane coupling agents

In the composition of the present invention, ink jet ejection performance stabilizers can be used and specific examples thereof include surfactants such as EFTOP EF301, EFTOP EF303 and EFTOP EF352 (trade names, manufactured by Shin-Akita Chemical Co., Ltd.), MEGAFAC F171, MEGAFAC F172, MEGAFAC F173 and MEGAFAC F178K (trade names, manufactured by DAINIPPON INK AND CHEMICALS, INCORPORATED), Fluorad FC430 and Fluorad FC431 (trade names, manufactured by Sumitomo 3M Co., Ltd.), Asahiguard AG710, Surflon S-382, Surflon SC-101, Surflon SC-102, Surflon SC-103, Surflon SC-104, Surflon SC-105 and Surflon SC-106 (trade names, manufactured by Asahi Glass Co., Ltd.), KP341 (trade name, manufactured by Shin-Etsu Chemical Co., Ltd.), and Polyflow No. 75 and Polyflow No. 95 (trade names, manufactured by KYOEISHA CHEMICAL Co., LTD.).

To enhance storage stability, ultraviolet inhibitors and plasticizers can be added to the resist composition and the jet printing ink composition of the present invention, as far as the object of the present invention is not adversely affected.

8. Process for Preparation of Resist Composition

The resist composition of the present invention is prepared by mixing the above respective components using a conventional method, dispersing and kneading using a kneader, a three-roll or a beads mill. However, the curable polyester having an oxetanyl group at the molecular end is preferably mixed after swelling with a solvent because it is hard to mix with or disperse in the other resin components. The curable polyester having an oxetanyl group at the molecular end can be easily dispersed by the above dispersion and kneading method.

The curable polyester having an oxetanyl group at the molecular end can be swollen only by kneading powders of the curable polyester having an oxetanyl group at the molecular end with an organic solvent. Preferably, the curable polyester having an oxetanyl group at the molecular end is melted with heating to a temperature higher than a melting point of the curable polyester having an oxetanyl group at the molecular end in the presence of the organic solvent and then cooled to room temperature because the swelling degree of the curable polyester having an oxetanyl group at the molecular end is enhanced and thus it becomes easy to disperse and knead the curable polyester having an oxetanyl group at the molecular end. Examples of preferable organic solvent used include N,N-dimethylformamide, N-methyl pyrrolidone and γ-butyrolactone.

9. Curing Method

The composition of the present invention can be formed into a cured product by forming a pattern on a print circuit board using a coating method such as screen printing method and subjecting to a heat treatment.

When heated to the melting point or higher, the curable polyester having an oxetanyl group at the molecular end is melted and reacts with the other resin component, and then cured by three-dimensional crosslinking. The curing temperature may be within a range from a melting point of the curable polyester having an oxetanyl group at the molecular end to a pyrolysis temperature of the resin component. Since the melting point of the curable polyester having an oxetanyl group at the molecular end used in the present invention is within a range from 40 to 250° C., the curing temperature is preferably within a range from 40 to 250° C., and more preferably from 80 to 200° C. When the curing temperature is lower than 40° C., required curing time is too long. The curing temperature of higher than 250° C. is not preferred because pyrolysis of the resin component occurs.

10. Process for Preparation of Jet Printing Ink Composition

The jet printing ink composition of the present invention is prepared by mixing the above respective components using a conventional method, dispersing and kneading using a kneader, a three-roll or a beads mill and diluting the mixture with a solvent (C) so as to adjust to a suitable viscosity.

The curable polyester having an oxetanyl group at the molecular end is preferably mixed after swelling with a solvent because it is hard to mix with or disperse in the other resin components. The curable polyester having an oxetanyl group at the molecular end can be easily dispersed by the above dispersion and kneading method.

The curable polyester having an oxetanyl group at the molecular end can be swollen only by kneading powders of the curable polyester having an oxetanyl group at the molecular end with a solvent (C). Preferably, the curable polyester having an oxetanyl group at the molecular end is melted with heating to a temperature higher than a melting point of the curable polyester having an oxetanyl group at the molecular end in the presence of the solvent (C) and then cooled to room temperature because the swelling degree of the curable polyester having an oxetanyl group at the molecular end is enhanced and thus it becomes easy to disperse and knead the curable polyester having an oxetanyl group at the molecular end. Examples of preferable organic solvent used include N,N-dimethylformamide, N-methyl pyrrolidone and γ-butyrolactone.

11. Printing Method

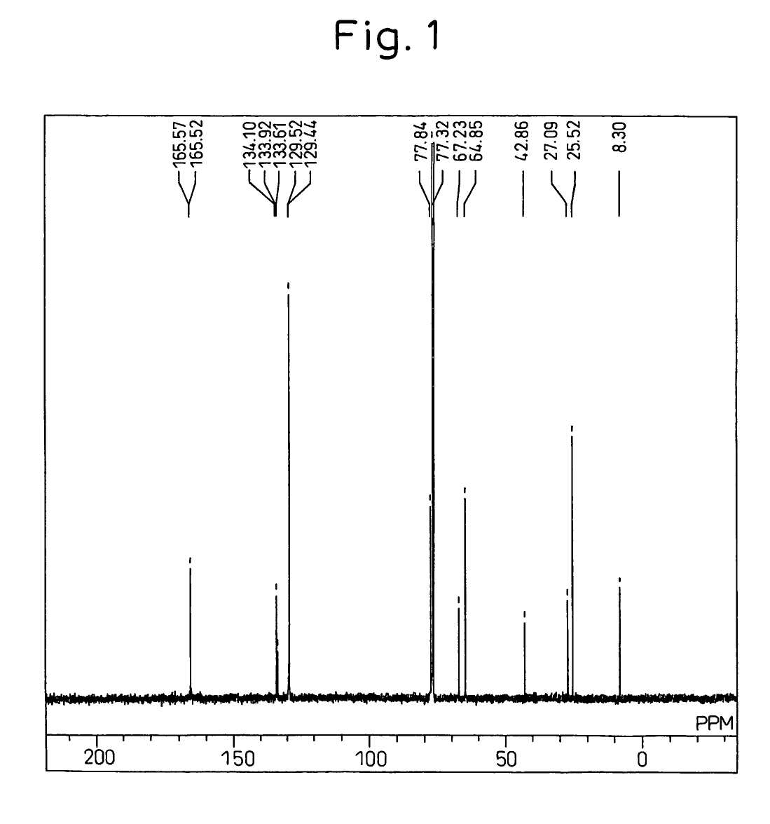

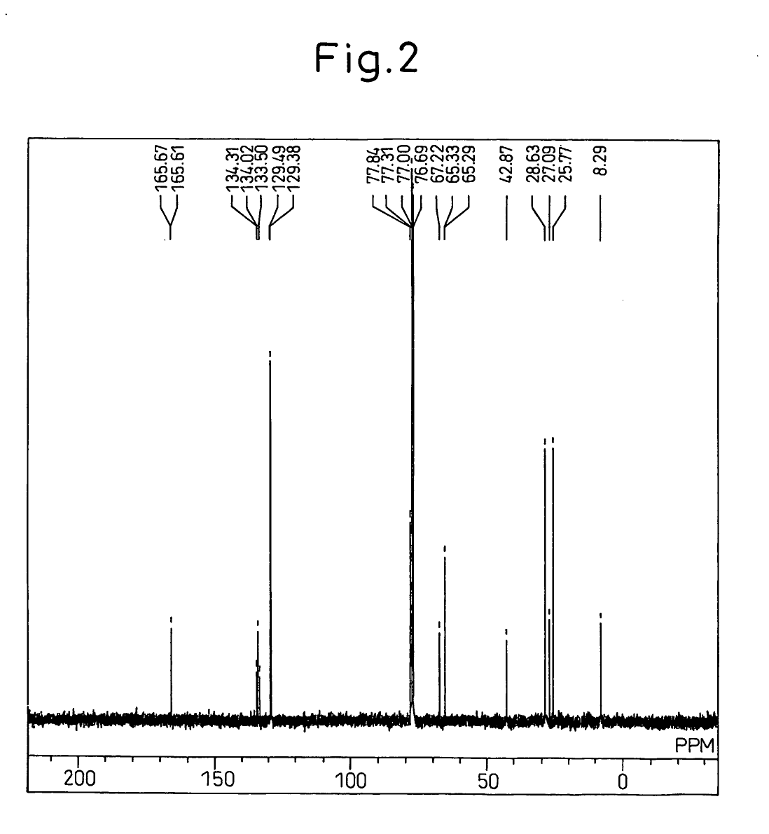

Pattern printing of the jet printing ink composition of the present invention can be performed by using various ink jet systems. For example, there can be used a system capable of printing while controlling ejection of the ink by applying a voltage signal to a piezoelectric element. An ink jet head (1) shown in FIG. 1 is a head using a piezoelectric element and plural nozzles (5) are formed on an ink ejection surface (3) of a body (2). Each nozzle (5) is provided with a piezoelectric element (4). As shown in FIG. 2, the piezoelectric element (4) is disposed corresponding to the nozzle (5) and an ink chamber (6). The ink is pressurized by applying an applied voltage Vh to the piezoelectric element (4) and contracting the piezoelectric element (4) to the direction of arrow as shown in FIGS. 2(a) to 2(c), thereby to eject a predetermined amount of ink droplet (7) through the nozzle (5).

In case of an ink jet system, a fine pattern can be formed because microsized ink droplet (7) can be made.

12. Curing Method

The composition of the present invention can be formed into a cured product by pattern printing using an ink jet system and subjecting to a heat treatment.

When heated to the melting point or higher, the curable polyester having an oxetanyl group at the molecular end is melted and reacts with the other resin component, and then cured by three-dimensional crosslinking. The curing temperature may be within a range from a melting point of the curable polyester having an oxetanyl group at the molecular end to a pyrolysis temperature of the resin component. Since the melting point of the curable polyester having an oxetanyl group at the molecular end used in the present invention is within a range from 40 to 250° C., the curing temperature is preferably within a range from 40 to 250° C., and more preferably from 80 to 200° C. When the curing temperature is lower than 40° C., required curing time is too long. The curing temperature of higher than 250° C. is not preferred because pyrolysis of the resin component occurs.

### EXAMPLES

The present invention will now be described by way of examples, but the present invention is not limited to the following examples.

### Working Example 1

### The Curable Polyester Having an Oxetanyl Group at the Molecular End

<Synthesis>

### Preparation Example 1

246.3 g (1.00 mol) of diallyl terephthalate (manufactured by Showa Denko K.K.), 116.2 g (1.00 mol) of 3-ethyl-3-hydroxymethyloxetane (manufactured by Ube Industries, Ltd.) and 0.25 g of dibutyltin oxide (manufactured by Tokyo Kasei Kogyo Co., Ltd.) were charged in a 500 ml four-necked separable flask equipped with a distillation apparatus and stirred in a nitrogen gas flow at 175° C., and then the mixture was reacted for 7 hours while distilling off allyl alcohol produced during the reaction. The reaction system was evacuated and the reaction was further conducted for 3 hours. The atmosphere in the reaction system was replaced by a nitrogen atmosphere under normal pressure and, after slow cooling, 45.06 g (0.500 mol) of 1,4-butanediol (manufactured by Tokyo Kasei Kogyo Co., Ltd.) was added, followed by stirring in a nitrogen gas flow at 175° C. and further reaction for 4 hours while distilling off allyl alcohol produced during the reaction. Then, 0.25 g of dibutyltin oxide (manufactured by Tokyo Kasei Kogyo Co., Ltd.) was added and the reaction was further conducted under reduced pressure for 10 hours. The atmosphere in the reaction system was replaced by a nitrogen atmosphere under normal pressure and, after slow cooling, 316.5 g of a white resin was obtained.

### Preparation Example 2

246.3 g (1.00 mol) of diallyl terephthalate (manufactured by Showa Denko K.K.), 116.2 g (1.00 mol) of 3-ethyl-3-hydroxymethyloxetane (manufactured by Ube Industries, Ltd.) and 0.25 g of dibutyltin oxide (manufactured by Tokyo Kasei Kogyo Co., Ltd.) were charged in a 500 ml four-necked separable flask equipped with a distillation apparatus and stirred in a nitrogen gas flow at 175° C., and then the mixture was reacted for 7 hours while distilling off allyl alcohol produced during the reaction. The reaction system was evacuated and the reaction was further conducted for 3 hours. The atmosphere in the reaction system was replaced by a nitrogen atmosphere under normal pressure and, after slow cooling, 59.09 g (0.500 mol) of 1,6-hexanediol (manufactured by Tokyo Kasei Kogyo Co., Ltd.) and 0.25 g of dibutyltin oxide (manufactured by Tokyo Kasei Kogyo Co., Ltd.) were added. After stirring in a nitrogen gas flow at 175° C., the mixture was reacted for 4 hours while distilling off allyl alcohol produced during the reaction. Then, the reaction was further conducted under reduced pressure for 4.5 hours. The atmosphere in the reaction system was replaced by a nitrogen atmosphere under normal pressure and, after slow cooling, 312.9 g of a white resin was obtained.

### Preparation Example 3

233.5 g (0.884 mol) of diallyl terephthalate (manufactured by Showa Denko K.K.), 102.7 g (0.884 mol) of 3-ethyl-3-hydroxymethyloxetane (manufactured by Ube Industries, Ltd.) and 0.23 g of dibutyltin oxide (manufactured by Tokyo Kasei Kogyo Co., Ltd.) were charged in a 500 ml four-necked separable flask equipped with a distillation apparatus and stirred in a nitrogen gas flow at 180° C., and then the mixture was reacted for 7.5 hours while distilling off allyl alcohol produced during the reaction. The reaction system was evacuated and the reaction was further conducted for 4.5 hours. The atmosphere in the reaction system was replaced by a nitrogen atmosphere under normal pressure and, after slow cooling, 63.73 g (0.442 mol) of 1,4-cyclohexanedimethanol (manufactured by Tokyo Kasei Kogyo Co., Ltd.) and 0.23 g of dibutyltin oxide (manufactured by Tokyo Kasei Kogyo Co., Ltd.) were added. After stirring in a nitrogen gas flow at 175° C., the mixture was reacted for 5.5 hours while distilling off allyl alcohol produced during the reaction. Then, the reaction was further conducted under reduced pressure for 14.5 hours. The atmosphere in the reaction system was replaced by a nitrogen atmosphere under normal pressure and, after slow cooling, 298.4 g of a white resin was obtained.

### Preparation Example 4

310.8 g (1.26 mol) of diallyl terephthalate (manufactured by Showa Denko K.K.), 39.17 g (0.631 mol) of ethylene glycol (manufactured by Wako Pure Chemicals Industries, Ltd.) and 0.31 g of dibutyltin oxide (manufactured by Tokyo Kasei Kogyo Co., Ltd.) were charged in a 500 ml four-necked separable flask equipped with a distillation apparatus and stirred in a nitrogen gas flow at 175° C., and then the mixture was reacted for 4 hours while distilling off allyl alcohol produced during the reaction. The reaction system was evacuated and the reaction was further conducted for 3.5 hours. The atmosphere in the reaction system was replaced by a nitrogen atmosphere under normal pressure and, after slow cooling, 146.6 g (1.26 mol) of 3-ethyl-3-hydroxymethyloxetane (manufactured by Ube Industries, Ltd.) and 0.62 g of dibutyltin oxide (manufactured by Tokyo Kasei Kogyo Co., Ltd.) were added. After stirring in a nitrogen gas flow at 175° C., the mixture was reacted for 4.5 hours while distilling off allyl alcohol produced during the reaction. Then, the reaction was further conducted under reduced pressure for 15 hours. The atmosphere in the reaction system was replaced by a nitrogen atmosphere under normal pressure and, after slow cooling, 351.0 g of a white resin was obtained.

<Structural Analysis>

Each of the resins of Preparation Examples 1 to 4 was dissolved in DMF at 120° C. and the resulting solution was added dropwise in a large amount of methanol. After removing the unreacted raw material by purification due to reprecipitation, the solution was vacuum-dried and subjected to the measurement of ¹³C-NMR. ¹³C-NMR was measured in deutrochloroform using JNM-AL400 manufactured by JEOL. The peak assignments were also conducted.

(1) A ¹³C-NMR chart of the resin obtained in Preparation Example 1 is shown in FIG. 1. The measurement results of ¹³C-NMR revealed that the resin is represented by the following formula (5) (provided that 1 is an integer of 1 or more). 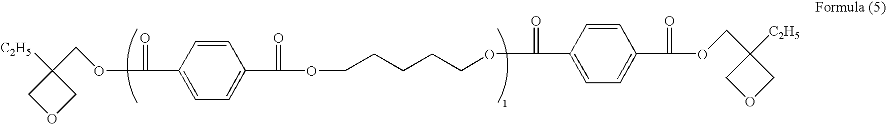
8.3 ppm: —CH₃
25.5 ppm: —OCH₂(CH₂)₂CH₂O—
27.1 ppm: —CH₂CH₃
42.9 ppm: quaternary carbon atom of oxetane ring
64.9 ppm: —OCH₂(CH₂)₂CH₂O—
67.2 ppm: —OCH₂—(CH₃) (CH₂O)₂
77.8 ppm: ether carbon atom of oxetane ring
129.4 ppm, 129.5 ppm, 133.6 ppm, 133.9 ppm, 134.1 ppm: carbon atom of benzene ring
165.5 ppm, 165.6 ppm: carbonyl carbon atom

(2) A ¹³C-NMR chart of the resin obtained in Preparation Example 2 is shown in FIG. 2. The measurement results of ¹³C-NMR revealed that the resin is represented by the following formula (6) (provided that 1 is an integer of 1 or more). 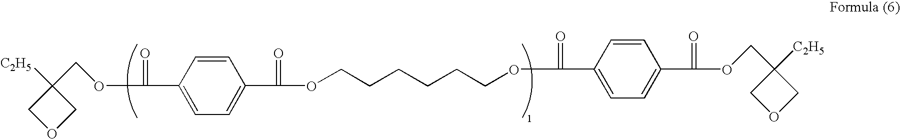
8.3 ppm: —CH₃
25.5 ppm, 28.6 ppm: —OCH₂(CH₂)₄CH₂—
27.1 ppm: —CH₂CH₃
42.9 ppm: quaternary carbon atom of oxetane ring
65.3 ppm: —OCH₂ (CH₂)₂CH₂—
67.2 ppm: —OCH₂—C(CH₃)(CH₂O)₂
77.8 ppm: ether carbon atom of oxetane ring
129.4 ppm, 129.5 ppm, 133.5 ppm, 134.0 ppm, 134.3 ppm: carbon atom of benzene ring
165.6 ppm, 165.7 ppm: carbonyl carbon atom

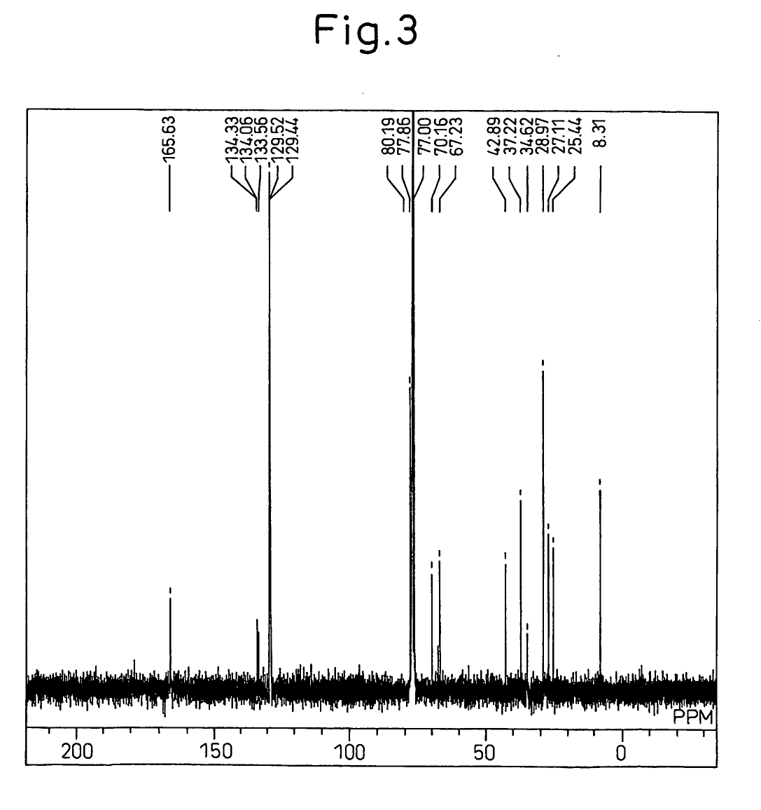

(3) A ¹³C-NMR chart of the resin obtained in Preparation Example 3 is shown in FIG. 3. The measurement results of ¹³C-NMR revealed that the resin is represented by the following formula (7) (provided that 1 is an integer of 1 or more). 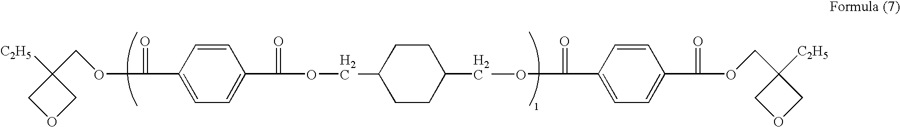
8.3 ppm: —CH₃
25.4 ppm, 29.0 ppm, 34.6 ppm, 37.2 ppm: cyclohexane ring carbon atom
27.1 ppm: —CH₂CH₃
42.9 ppm: quaternary carbon atom of oxetane ring
67.2 ppm: —OCH₂—C(CH₃)(CH₂O)₂
70.2 ppm: —OCH₂C₆H₁₀CH₂O—
80.2 ppm: ether carbon atom of oxetane ring
129.4 ppm, 129.5 ppm, 133.6 ppm, 134.1 ppm, 134.3 ppm: carbon atom of benzene ring
165.6 ppm: carbonyl carbon atom

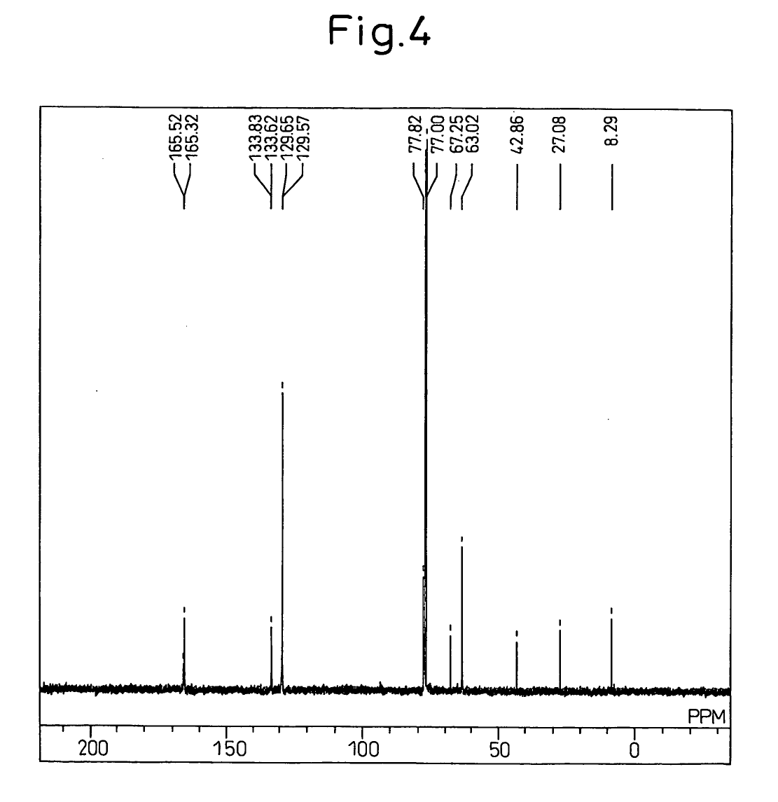

(4) A ¹³C-NMR chart of the resin obtained in Preparation Example 4 is shown in FIG. 4. The measurement results of ¹³C-NMR revealed that the resin is represented by the following formula (8) (provided that 1 is an integer of 1 or more). 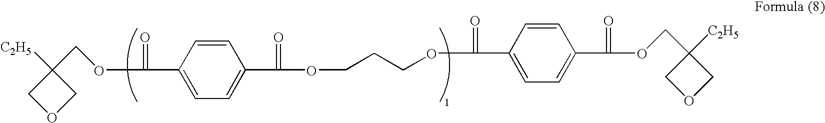
8.3 ppm: —CH₃
27.1 ppm: —CH₂CH₃
42.9 ppm: quaternary carbon atom of oxetane ring
63.0 ppm: —OCH₂CH₂O—
67.3 ppm: —OCH₂—C(CH₃)(CH₂O)₂
77.8 ppm: ether carbon atom of oxetane ring
129.6 ppm, 133.6 ppm, 133.8 ppm: carbon atom of benzene ring
165.3 ppm, 165.5 ppm: carbonyl carbon atom
   <Evaluation of Curability>

### Working Examples 1-1 to 1-4

Each of the resins having an oxetanyl group at both ends of Preparation Examples 1 to 4 was dissolved in chloroform (manufactured by Junsei Chemical Co., Ltd.) in the content of 30% by weight. To 20 g of the chloroform solution, 1.9 g of 1,2,3,4-butanetetracarboxylic acid (manufactured by New Japan Chemical Co., Ltd. under the trade name of Rikacid BT-W) and 0.60 g of tetraphenylphosphonium bromide (manufactured by Tokyo Kasei Kogyo Co., Ltd.) were added, followed by stirring for 3 hours. Then, the solution was applied onto a glass fiber-reinforced epoxy resin substrate in a thickness of about 30 μm using an applicator. Each coated substrate was dried at room temperature for 30 minutes to remove chloroform and then heat-cured under the conditions of 170° C. for 10, 20 and 30 minutes (Preparation Examples 1, 2 and 4). In Preparation Example 3, the coated substrate was heat-cured under the conditions of 250° C. for 10, 20 and 30 minutes. Curability was evaluated by the solvent resistance test (rubbing test using chloroform) of each coating film after heat curing. The results are shown in Table 1. The results in Table 1 show that heating cures each of the resins having an oxetanyl group at both ends of Preparation Examples 1 to 4.

TABLE 1
Evaluation results of curability

| Working Examples | | 1-1 | 1-2 | 1-3 | 1-4 |
|---|---|---|---|---|---|
| Raw resin | | Preparation | Preparation | Preparation | Preparation |
| | | Example 1 | Example 2 | Example 3 | Example 4 |
| Curing time | 10 min. | 3 | 3 | 2 | 3 |
| | 20 min. | 2 | 1 | 1 | 2 |
| | 30 min. | 1 | 1 | 1 | 1 |

Evaluation Criteria
1: no abnormality was recognized in coating film
2: coating film was slightly whitened
3: coating film was dissolved
   <Measurement of Melting Point of the Curable Resins Having an Oxetanyl Group at both Ends>

Each of the crystalline resins of Preparation Examples 1 and 2 was melted with heating in N,N-dimethylformamide (manufactured by Junsei Chemical Co., Ltd.) and purified by reprecipitation with methanol, and then methanol was removed by vacuum drying. A melting point of the resulting crystalline resins of Preparation Examples 1 and 2 was measured by a differential scanning analyzer (DSC 8230, manufactured by Rigaku Corporation). The measurement was performed in a nitrogen atmosphere at a heating rate of 10° C./min within a range from 40 to 200° C. The measurement was performed twice. The melting point measured second time is shown in Table 2.

TABLE 2

| Resin | Melting point (° C.) |
|---|---|
| Preparation Example 1 | 155 |
| Preparation Example 2 | 96 |

<Synthesis of other Resin Components>

In addition to the curable resins having an oxetanyl group at both ends of Preparation Examples 1 to 4, which are formulated in the compositions of the following Working Examples or Comparative Examples, resins to be incorporated into the composition were synthesized so as to obtain characteristics suited for used as a solder resist or an interlayer insulation film

### Preparation Example 5

### Polyester Resin Having Carboxyl Group

In a four-necked flask equipped with a thermometer, a cooling tube, a nitrogen introducing tube and a stirrer, Epikote 828 (bisphenol A type epoxy resin, epoxy equivalent: 189, manufactured by Japan Epoxy Resin Co., Ltd.) (227 g), adipic acid (manufactured by Tokyo Kasei Kogyo Co., Ltd.) (94 g, 0.64 mol), triphenylphosphine (manufactured by Tokyo Kasei Kogyo Co., Ltd.) (5.0 g) and ethylcarbitol acetate (manufactured by Tokyo Kasei Kogyo Co., Ltd.) (211 g) were charged and the mixture was reacted until an acid value became constant in a nitrogen atmosphere at 120° C. Furthermore, succinic anhydride (manufactured by Tokyo Kasei Kogyo Co., Ltd.) (72 g, 0.72 mol) was added and the mixture was reacted at 120° C. The reaction was performed at 120° C. until an adsorption of a carbonyl group disappears by FT-IR. The resulting polyester resin having a carboxyl group had a solid content acid value of 90 mgKOH/g and a solid content of 65% by weight.

### Preparation Example 6

### Polyester Resin Having Epoxy group

In a four-necked flask equipped with a thermometer, a cooling tube, a nitrogen introducing tube and a stirrer, Epikote 828 (236 g), adipic acid (132 g, 0.90 mol), triphenylphosphine (4.7 g) and ethylcarbitol acetate (198 g) were charged and the mixture was reacted in a nitrogen atmosphere at 120° C. until the acid value nearly disappeared. The resulting polyester resin having an epoxy group had a solid content of 65% by weight.

### Working Example 2 and Comparative Example 2

### Preparation of Solder Resist Composition

According to the formulation (unit: parts by weight) shown in Table 3, bases and curing agents were separately prepared by kneading three times in a three-roll mikk (Model RIII-IRM-2, manufactured by Odaira Seisakusho, Ltd.) to prepare thermosetting compositions of Working Examples 2-1 to 2-2 and Comparative Examples 2-1 to 2-2.

To the to the curable resins having an oxetanyl group at both ends of Preparation Examples 1 and 2, γ-butyrolactone was added so that the solid content became 50% by weight and, after dissolving with heating to 120° C., the solution was slowly cooled to swell the resins with γ-butyrolactone.

<Evaluation of Solder Resist Composition>

Line width, bleeding, flexibility, solder heat resistance and electric insulation properties (insulation resistance) were evaluated by the following procedures. The results are shown in Table 4.

Line Width

Each of the solder resist compositions of Working Examples 2-1 to 2-2 and Comparative Examples 2-1 to 2-2 was applied on a 75 μm thick polyimide film [Kapton® 300H, manufactured by DUPONT-TORAY CO., LTD.] by screen printing using a #150 polyester plate capable of printing a line having a width of 300 μm. The width of the printed thin line was measured by a microscope (VH-8000, manufactured by Keyence Corporation), allowed to stand at room temperature for one hour and then heat-cured at 160° C. for 20 minutes. With respect to the respective heat-cured substrates, the line width was measured again by a microscope.

Bleeding

Each of the solder resist compositions of Working Examples 2-1 to 2-2 and Comparative Examples 2-1 to 2-2 was applied on an epoxy resin substrate by screen printing using a #150 polyester plate capable of printing a line having a width of 300 μm. Each substrate was allowed to stand at room temperature for one hour and then heat-cured at 160° C. for 20 minutes. With respect to the respective heat-cured substrates, the width of bleeding was measured by a microscope.

Flexibility

Each of the solder resist compositions of Working Examples 2-1 to 2-2 and Comparative Examples 2-1 to 2-2 was applied by screen printing using a #100 polyester plate, followed by heat curing at 160° C. for 20 minutes. As the substrate, a 25 μm thick polyimide film [Kapton® 100H, manufactured by DUPONT-TORAY CO., LTD.] was used. The polyimide film obtained by coating the solder resist composition and heat curing was folded by 180° while facing the coated surface outside. Then, it was examined whether or not there arises whitening of the cured film. The flexibility was evaluated by the following criteria.

Circle (∘): no whitening of cured film

Cross (x): whitening or cracking of cured film occurs

Solder Heat Resistance

According to the test procedure defined in JIS C-6481, each of the solder resist compositions of Working Examples 2-1 to 2-2 and Comparative Examples 2-1 and 2-2 was applied by screen printing using a #100 polyester plate, followed by heat curing at 160° C. for 20 minutes. As the substrate, a printed board made of a laminated polyimide film (thickness: 50 μm) comprising a copper foil (thickness: 35 μm) formed on one surface [Upicel® N, manufactured by Ube Industries, Ltd.] was used after washing with an aqueous 1% sulfuric acid solution, washing with water and then drying with an air flow. The coated substrate obtained by application of the solder resist composition and heat curing was floated on a solder bath at 260° C. for 5 seconds, and this cycle was repeated. Every cycle, the cured film were visually observed. The solder heat resistance was evaluated by maximum number of cycles at which neither “blister” nor “solder penetration” was recognized.

Electric Insulation Properties (Insulation Resistance)

On IPC-C (comb-shaped pattern) of a commercially available substrate (IPC standard), each of the solder resist compositions of Working Examples 2-1 to 2-2 and Comparative Examples 2-1 and 2-2 was applied by screen printing using a #100 polyester plate, followed by heat curing at 160° C. for 20 minutes. The substrate was allowed to stand in an atmosphere at 85° C. and a relative humidity of 85% for 192 hours. Before and after this treatment, insulation resistance was measured and electric insulation properties were evaluated. The insulation resistance was measured by an electric insulation resistance tester at a voltage applied state after applying 100 V DC to the substrate before and after the treatment and keeping for one minute in accordance with JIS C5012.

TABLE 3
Formulation of resist composition for solder resist

| | | | Working Example | Working Example |
|---|---|---|---|---|
| | | | 2-1 | 2-2 |
| Base | Crystalline | Preparation Example 1 (terminal oxetanyl group BL: | 30.0 (15.0) | |
| | resin | 50% by weight) *10 | | |
| | | Preparation Example 2 (terminal oxetanyl group BL: | | 30.0 (15.0) |
| | | 50% by weight) *10 | | |
| | Other resin | Preparation Example 5 (65% by weight) | 46.2 (30.0) | 46.2 (30.0) |
| | components | EPPN-501H *1 (solid content: 80% by weight, ECA *2 | 22.5 (18.0) | 22.5 (18.0) |
| | | solution) | | |
| | Colorant | Phthalocyanine green | 1.0 (1.0) | 1.0 (1.0) |
| | Inorganic | Hi-Filler #5000PJ *3 | 10.5 (10.5) | 10.5 (10.5) |
| | filler | B34 *4 | 25.0 (25.0) | 25.0 (25.0) |
| | Additive | TSA-750S *5 | 0.5 (0.5) | 0.5 (0.5) |
| | Diluent solvent | ECA | 3.0 (0.0) | 3.0 (0.0) |
| | | Total of base | 138.7 (100.0) | 138.7 (100.0) |
| Curing | Binder resin | Halon 80 *6 (solid content 70%, DPGM *7 solution) | 6.0 (4.2) | 6.0 (4.2) |
| agent | Curing catalyst | Curezol C11ZCNS *8 | 2.0 (2.0) | 2.0 (2.0) |
| | Inorganic | Hi-Filler *5000PJ | 1.6 (1.6) | 1.6 (1.6) |
| | filler | | | |
| | Additive | Aerogyl #380 *9 | 0.1 (0.1) | 0.1 (0.1) |
| | Diluent solvent | ECA | 1.0 (0.0) | 1.0 (0.0) |
| | | Total of curing agent | 10.7 (7.9) | 10.7 (7.9) |
| Ratio of base to curing agent | | | 138.7:10.7 | 138.7:10.7 |
| | | | Comparative | Comparative |
| | | | Example 2-1 | Example 2-2 |
| Base | Other resin | Preparation Example 6 (65% by weight) | 46.2 (30.0) | |
| | component | EPPN-501H (solid content: 80% by weight, ECA solution) | 22.5 (18.0) | 22.5 (18.0) |
| | | Epikote 828 *11 | 15.0 (15.0) | 15.0 (15.0) |
| | Curing agent | IPU-22AH *12 | | 30.0 (30.0) |
| | for epoxy | | | |
| | resin | | | |
| | Colorant | Phthalocyanine green | 1.0 (1.0) | 1.0 (1.0) |
| | Inorganic filler | Hi-Filler #5000PJ | 10.5 (10.5) | 10.5 (10.5) |
| | | B34 | 25.0 (25.0) | 25.0 (25.0) |
| | Additive | TSA-750S | 0.5 (0.5) | 0.5 (0.5) |
| | Diluent solvent | ECA | 8.0 (0.0) | 3.0 (0.0) |
| | | Total of base | 128.7 (100.0) | 107.5 (100.0) |
| Curing | Binder resin | Halon 80 (solid content: 70%, DPGM solution) | 6.0 (4.2) | 6.0 (4.2) |
| agent | Curing catalyst | Curezol C11ZCNS | 2.0 (2.0) | 2.0 (2.0) |
| | Inorganic filler | Hi-Filler #5000PJ | 1.6 (1.6) | 1.6 (1.6) |
| | Additive | Aerogyl #380 | 0.1 (0.1) | 0.1 (0.1) |
| | Diluent solvent | ECA | 1.0 (0.0) | 1.0 (0.0) |
| | | Total of curing agent | 10.7 (7.9) | 10.7 (7.9) |

| | | |
|---|---|---|
| Ratio of base to curing agent | 128.7:10.7 | 133.9:10.7 |

Solid content in the parenthesis
*1 EPPN-501H: Triphenylmethane epoxy resin (manufactured by NIPPON KAYAKU CO., LTD.)
*2 ECA: Ethylcarbitol acetate (= diethylene glycol ethyl ether acetate, manufactured by TOKYO KASEI KOGYO Co., Ltd.)
*3 Hi-Filler #5000PJ: Talc (manufactured by Matsumura Sangyo)
*4 B34: Barium sulfate (manufactured by SAKAI CHEMICAL INDUSTRY CO., LTD.)
*5 TSA-750S: polyalkylsiloxane (manufactured by Toshiba Silicone Co., Ltd.)
*6 Halon 80: Acetophenone resin (manufactured by Honshu Chemical Industries Co., Ltd.)
*7 DPGM: Dipropylene glycolmethyl ether
*8 1-cyanoethyl-2-undecylimidazolium trimellitate (manufactured by Shikoku Corp.)
*9 Aerogyl #380: Silicon dioxide (manufactured by Aerogyl Japan Co., Ltd.)
*10 BL: γ-butyrolactone (TOKYO KASEI KOGYO Co., Ltd.)
*11 Epikote 828: Bisphenol A type epoxy resin (manufactured by Japan Epoxy Resin Co., Ltd.)
*12 IPU-22AH: 7,12-dimethyl-7,11-octadecadiene-1,18-dicarboxylic partial anhydride (manufactured by Okamura Oil Mill, Ltd.)

TABLE 4
Evaluation results

| | | Example | Example | Comparative | Comparative |
|---|---|---|---|---|---|
| | | 2-1 | 2-2 | Example 2-1 | Example 2-2 |
| Line width | Before heat | 280 | 280 | 280 | 280 |
| (μm) | curing | | | | |
| | After heat | 300 | 290 | 420 | 320 |
| | curing | | | | |
| Bleeding | | none | none | none | observed |
| | | | | | (0.3 mm) |
| Flexibility (180° | | ◯ | ◯ | ◯ | ◯ |
| folding) | | | | | |
| Solder heat resistance | | twice | twice | twice | twice |
| (260° C. × 5 sec) | | | | | |
| Electric | Before | 3.7 × 10¹³ | 5.5 × 10¹³ | 2.8 × 10¹³ | 3.8 × 10¹³ |
| insulation | treatment | | | | |
| properties | After | 3.2 × 10¹² | 1.9 × 10¹² | 1.9 × 10¹² | 2.7 × 10¹² |
| (Ω) | treatment | | | | |

### Working Example 3 and Comparative Example 3

### Preparation of Jet Printing Ink Composition

According to the formulation (unit: parts by weight) shown in Table 5, bases and curing agents were separately prepared by a dispersion treatment using a paint shaker (manufactured by ASADA IRON WORKS. CO., LTD.) for 3 hours. Before use, they were mixed to prepare jet printing ink compositions of Working Examples 3-1 to 3-3 and Comparative Examples 3-1 to 3-2.

To the crystalline resins of Preparation Examples 1 and 2, γ-butyrolactone was added so that the solid content became 30% by weight and, after dissolving with heating to 120° C., the solution was slowly cooled to swell the resins with γ-butyrolactone (Working Examples 3-1 to 3-2). With respect to the resin of Preparation Example 2, a solution having a solid content of 50% by weight was also prepared in the same manner (Working Example 3-3).

<Evaluation of Jet Printing Ink Composition>

Line width, bleeding, solder heat resistance and electric insulation properties (insulation resistance) were evaluated by the following procedures. The results are shown in Table 6.

Line Width

Using each of the jet printing ink compositions of Working Examples 3-1 to 3-3 and Comparative Examples 3-1 to 3-2, a thin line having a width of 100 μm was pattern-printed on a 75 μm thick polyimide film [Kapton® 300H, manufactured by DUPONT-TORAY CO., LTD.) by an ink jet applicator shown in FIG. 1 and FIG. 2. The printed thin line having a width of 100 μm was measured by a microscope (VH-8000, manufactured by Keyence Corporation), allowed to stand at room temperature for one hour and then heat-cured at 160° C. for 20 minutes. With respect to the respective heat-cured substrates, the line width was measured again by a microscope.

Bleeding

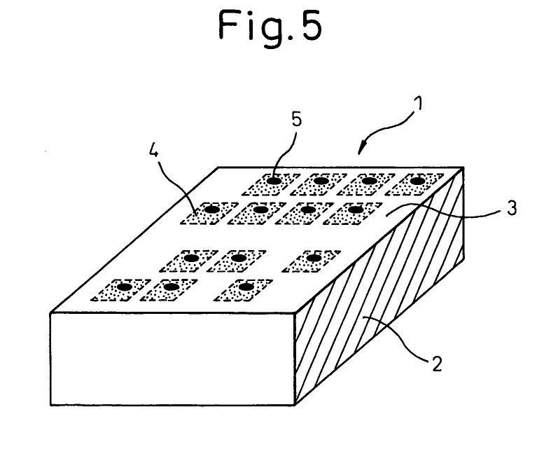

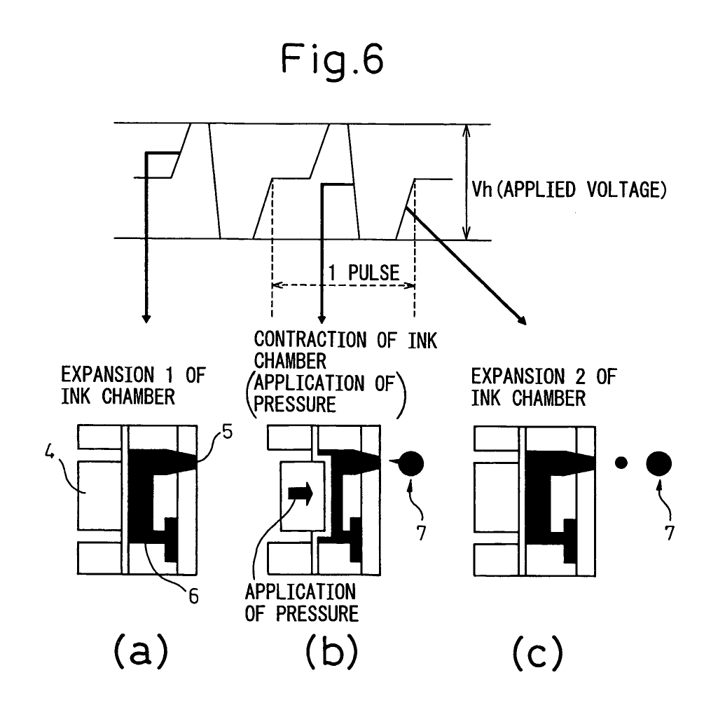

Using each of the jet printing ink compositions of Working Examples 3-1 to 3-3 and Comparative Examples 3-1 to 3-2, a thin line having a width of 100 μm was pattern-printed on an epoxy resin substrate by an ink jet applicator shown in FIG. 5 and FIG. 6. Each substrate was allowed to stand at room temperature for one hour and then heat-cured at 160° C. for 20 minutes. With respect to the respective heat-cured substrates, the width of bleeding was measured by a microscope.

Solder Heat Resistance

According to the test procedure defined in JIS C-6481, each of the jet printing ink compositions of Working Examples 3-1 to 3-3 and Comparative Examples 3-1 and 3-2 was pattern-printed by an ink jet applicator shown in FIG. 5 and FIG. 6, followed by heat curing at 160° C. for 20 minutes. As the substrate, a printed board made of a laminated polyimide film (thickness: 50 μm) comprising a copper foil (thickness: 35 μm) formed on one surface (Upicel® N, manufactured by Ube Industries, Ltd.] was used after washing with an aqueous 1% sulfuric acid solution, washing with water and then drying with an air flow. The coated substrate obtained by application of the jet printing ink composition and heat curing was floated on a solder bath at 260° C. for 5 seconds, and this cycle was repeated. Every cycle, “blister” and “solder penetration” of the cured film were visually observed. The solder heat resistance was evaluated by maximum number of cycles at which no change was recognized.

Electric Insulation Properties (Insulation Resistance)

On IPC-C (comb-shaped pattern) of a commercially available substrate (IPC standard), pattern printing was performed by an ink jet applicator shown in FIG. 5, FIG. 6, followed by heat curing at 160° C. for 20 minutes. The substrate was allowed to stand in an atmosphere at 85° C. and a relative humidity of 85% for 192 hours. Before and after this treatment, insulation resistance was measured and electric insulation properties were evaluated. The insulation resistance was measured by an electric insulation resistance tester at a voltage applied state after applying 100 V DC to the substrate before and after the treatment and keeping for one minute in accordance with JIS C5012.

TABLE 5
Formulation of jet printing ink composition for solder resist

| | | | Working Example | Working Example |
|---|---|---|---|---|
| | | | 3-1 | 3-2 |
| Base | Crystalline | Preparation Example 1 (terminal oxetanyl | 80.0 (24.0) | |
| | resin | group BL: 70% by weight) *6 | | |
| | | Preparation Example 2 (terminal oxetanyl | | 80.0 (24.0) |
| | | group BL: 70% by weight) *6 | | |
| | Other resin | Preparation Example 5 (65% by weight) | 73.8 (48.0) | 73.8 (48.0) |
| | components | EPPN-501H *1 (solid content: 80% by | 33.8 (27.0) | 33.8 (27.0) |
| | | weight, ECA *2 solution) | | |
| | Colorant | Phthalocyanine green | 1.0 (1.0) | 1.0 (1.0) |
| | Diluent | ECA | 61.4 (0.0) | 61.4 (0.0) |
| | solvent | | | |
| | | Total of base | 250.0 (100.0) | 250.0 (100.0) |
| Curing | Binder resin | Halon 80 *3 (solid content 70%, DPGM *4 | 6.0 (4.2) | 6.0 (4.2) |
| agent | | solution) | | |
| | Curing | Curezol C11ZCNS *5 | 2.0 (2.0) | 2.0 (2.0) |
| | catalyst | | | |
| | Diluent | ECA | 7.5 (0.0) | 7.5 (0.0) |
| | solvent | | | |
| | | Total of curing agent | 15.5 (6.2) | 15.5 (6.2) |
| Ratio of base to curing agent | | | 250.0:15.5 | 250.0:15.5 |
| | | | Working Example | |
| | | | 3-3 | |
| Base | Crystalline | Preparation Example 2 (terminal oxetanyl | 84.0 (42.0) | |
| | resin | group BL: 50% by weight) | | |
| | Other resin | Preparation Example 5 (65% by weight) | 46.2 (30.0) | |
| | component | EPPN-501H (solid content: 80% by weight, | 33.8 (27.0) | |
| | | ECA solution) | | |
| | Colorant | Phthalocyanine green | 1.0 (1.0) | |
| | Diluent | ECA | 85.0 (0.0) | |
| | solvent | | | |
| | | Total of base | 250.0 (100.0) | |
| Curing | Binder resin | Halon 80 (solid content: 70%, DPGM solution) | 6.0 (4.2) | |
| agent | Curing | Curezol C11ZCNS | 2.0 (2.0) | |
| | catalyst | | | |
| | Diluent | ECA | 7.5 (0.0) | |
| | solvent | | | |
| | | Total of curing agent | 15.5 (6.2) | |
| Ratio of base to curing agent | | | 250.0:15.5 | |
| | | | Comparative | Comparative |
| | | | Example 3-1 | Example 3-2 |
| Base | Crystalline | | | |
| | resin | | | |
| | Other resin | Synthesis Example 6 (65% by weight) | 73.8 | |
| | component | | (48.0) | |
| | | EPPN-501H (solid content: 80% by | 33.8 | 33.8 |
| | | weight, ECA solution) | (27.0) | (27.0) |
| | | Epikote 828 *7 | 24.0 | 24.0 |
| | | | (24.0) | (24.0) |
| | Curing agent for | IPU-22AH *8 | | 48.0 |
| | epoxy resin | | | (48.0) |
| | Colorant | Phthalocyanine green | 1.0 | 1.0 |
| | | | (1.0) | (1.0) |
| | Diluent solvent | ECA | 117.4 | 43.2 |
| | | | (0.0) | (0.0) |
| | | Total of base | 250.0 | 150.0 |
| | | | (100.0) | (100.0) |
| Curing | Binder resin | Halon 80 (solid content: 70%, DPGM | 6.0 | 6.0 |
| agent | | solution) | (4.2) | (4.2) |
| | Curing catalyst | Curezol C11ZCNS | 2.0 | 2.0 |
| | | | (2.0) | (2.0) |
| | Diluent solvent | ECA | 7.5 | 7.5 |
| | | | (0.0) | (0.0) |
| | | Total of curing agent | 15.5 | 15.5 |
| | | | (6.2) | (6.2) |

| | | |
|---|---|---|
| Ratio of base to curing agent | 250.0:15.5 | 150.0:15.5 |

Solid content in the parenthesis
*1 EPPN-501H: Triphenylmethane epoxy resin (manufactured by NIPPON KAYAKU CO., LTD.)
*2 ECA: Ethylcarbitol acetate (= diethylene glycol ethyl ether acetate, manufactured by TOKYO KASEI KOGYO Co., Ltd.)
*3 Halon 80: Acetophenone resin (manufactured by Honshu Chemical Industries Co., Ltd.)
*4 DPGM: Dipropylene glycolmethyl ether
*5 1-cyanoethyl-2-undecylimidazolium trimellitate (manufactured by Shikoku Corp.)
*6 BL: γ-butyrolactone (TOKYO KASEI KOGYO Co., Ltd.)
*7 Epikote 828: Bisphenol A type epoxy resin (manufactured by Japan Epoxy Resin Co., Ltd.)
*8 IPU-22AH: 7,12-dimethyl-7,11-octadecadiene-1,18-dicarboxylic partial anhydride (manufactured by Okamura Oil Mill, Ltd.)

TABLE 6
Evaluation results

| Working | Working | Working | | |
|---|---|---|---|---|
| Example | Example | Example | Comparative | Comparative |
| 3-1 | 3-2 | 3-3 | Example 3-1 | Example 3-2 |

Line width (μm)

| | | | | | |
|---|---|---|---|---|---|
| Before heat | 100 | 100 | 100 | 100 | 100 |
| curing | | | | | |
| After heat | 110 | 100 | 100 | 200 | 250 |
| curing | | | | | |
| Bleeding | none | none | none | none | (0.1 mm) |
| Solder heat | twice | twice | twice | twice | twice |
| resistance | | | | | |
| (260° C. × 5 sec) | | | | | |
| Electric | | | | | |
| insulation | | | | | |
| properties (Ω) | | | | | |
| Before treatment | 5.7 × 10¹³ | 3.5 × 10¹³ | 1.0 × 10¹² | 1.8 × 10¹³ | 2.4 × 10¹³ |
| After treatment | 3.2 × 10¹² | 1.2 × 10¹² | 1.1 × 10¹² | 1.6 × 10¹² | 1.3 × 10¹² |

### Effect of the Invention

A novel curable polyester having an oxetanyl group at the molecular end of the present invention can be preferably used as various coating materials, adhesives and molding materials because it is easily cured by heat or light and is excellent in flexibility, adhesion and mechanical strength.

The resist composition containing a novel curable polyester having an oxetanyl group at the molecular end of the present invention is excellent in line width retention of a thin line because neither bleeding nor sagging upon heat curing occurs, and also can be preferably used as a thermosetting solder resist for forming a pattern with high accuracy or an interlayer insulation film.

The jet printing ink composition containing a novel curable polyester having an oxetanyl group at the molecular end of the present invention is excellent in line width retention of a thin line pattern because neither bleeding nor sagging upon heat curing occurs, and also can be preferably used to produce a print circuit board to which high accuracy is required because printing can be performed according to an ink jet system.

1. A curable polyester having at least one oxetanyl group at the molecular ends.

2. The curable polyester according to claim 1, which is obtained by transesterification of a compound (A) represented by the following formula (1): 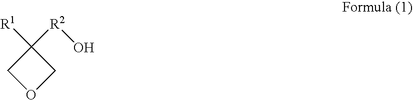
(wherein R¹ represents a hydrogen atom or an alkyl group having 1 to 6 carbon atoms, and R² represents an alkylene group having 1 to 6 carbon atoms), a compound (B) represented by the following formula (2):
R³ [symbol] COOR⁴)ₙ Formula (2)
(wherein R³ represents a di- to tetra-valent organic group, R⁴ represents an alkyl or alkenyl group having 1 to 6 carbon atoms, and n represents an integer of 2 to 4) and a compound (C) represented by the following formula (3):
R⁵ [symbol] OH)ₘ Formula (3)
(wherein R⁵ represents a di- to eicosa-valent organic group, and m represents an integer of 2 to 20).

3. A curable polyester having an oxetanyl group at both molecular ends according to claim 1, which has a structure represented by following formula (4): 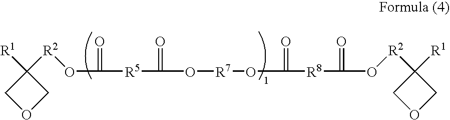
(wherein R¹ represents a hydrogen atom or an alkyl group having 1 to 6 carbon atoms, R² represents an alkylene group having 1 to 6 carbon atoms, R⁶ and R⁷ each represents a divalent organic group, and 1 represents an integer of 0 to 50).

4. A cured product obtained by curing the curable polyester of claim 1.

5. A process for preparing a curable polyester, which comprises transesterifying a compound (A) represented by the following formula (1): 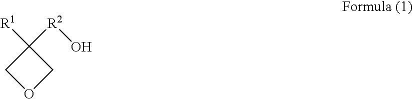
(wherein R¹ represents a hydrogen atom or an alkyl group having 1 to 6 carbon atoms, and R² represents an alkylene group having 1 to 6 carbon atoms), a compound (B) represented by the following formula (2):
R³ [symbol] COOR⁴)ₙ Formula (2)
(wherein R³ represents a di- to tetra-valent organic group, R⁴ represents an alkyl or alkenyl group having 1 to 6 carbon atoms, and n represents an integer of 2 to 4) and a compound (C) represented by the following formula (3):
R⁵ [symbol] OH)ₘ Formula (3)
(wherein R⁵ represents a di- to eicosa-valent organic group, and m represents an integer of 2 to 20).

6. A resist composition comprising the curable polyester of claim 1.

7. The resist composition according to claim 6, wherein the content of the curable polyester is from 3 to 50% by weight based on the resin component of the composition.

8. An ink comprising the resist composition of claim 6 and a colorant.

9. A method for curing a resist composition, which comprises, performing pattern printing of the resist composition of claim 6 on a substrate, and curing a curable polyester having at least one oxetanyl group at the molecular ends while melting with heating.

10. The method for curing a resist composition according to claim 9, wherein a heat melting or heat curing temperature of the curable polyester is from 40 to 250° C.

11. A heat cured product of the resist composition of claim 6.

12. An insulation protective film comprising a cured product of the resist composition of claim 6.

13. An interlayer insulation film comprising a cured product of the resist composition of claim 6.

14. A print circuit board comprising the insulation protective film of claim 12.

15. A print circuit board comprising the interlayer insulation film of claim 13.

16. A jet printing ink composition comprising the curable polyester of claim 1.

17. The jet printing ink composition according to claim 16, wherein the content of the curable polyester is from 3 to 50% by weight based on the resin component of the composition.

18. The jet printing ink composition according to claim 16, which comprises an epoxy resin (B) as the resin component other than the curable polyester.

19. The jet printing ink composition according to claim 16, wherein resins in the essential component composition are dissolved in a solvent (C) or dispersed in the solvent (C).

20. The jet printing ink composition according to claim 19, wherein the solvent (C) contains a solvent component having a boiling point of 180 to 260° C. and a vapor pressure at 20° C. of 133 Pa or less in the amount of 60% by weight or more based on the total amount of the solvent.

21. A cured product obtained by drying and heating the solvent (C) of jet printing ink composition of claim 19.

22. A method for curing a jet printing ink composition, which comprises, performing pattern printing on a substrate using the composition of claim 16 according to an ink jet system, and curing the curable polyester while melting with heating.

23. An insulation protective film comprising a cured product of the jet printing ink composition of claim 16.

24. An interlayer insulation film comprising a cured product of the jet printing ink composition of claim 16.

25. A print circuit board comprising the insulation protective film of claim 23.

26. A print circuit board comprising the interlayer insulation film of claim 24.
